(19) United States
(12) Patent Application Publication
(10) Pub. No.: US 2011/0075649 A1
(43) Pub. Date: Mar. 31, 2011

(54) METHOD AND SYSTEM OF FREQUENCY DIVISION MULTIPLEXING

(75) Inventor: Daoben Li, Shenzhen (CN)

(73) Assignee: Research Institute of Tsinghua University in Shenzhen, Shenzhen (CN)

(21) Appl. No.: 12/558,535

(22) Filed: Sep. 13, 2009

(51) Int. Cl. H04J 1/00

(52) U.S. Cl. 370/343

(57) ABSTRACT

This invention is a method about frequency multiplex. We employ numbers of sub-carriers whose frequency spectrum are overlapped each other to modulate the transmitted data sequences, and then we get the complex modulated signals. In the receiver point, we make use of one mapping between the overlapped signals' spectrum and the transmitted data sequences to detect the transmitted data sequences. By overlapping the adjacent sun-carriers, this invention can greatly increase the spectrum efficiency, and the more the multiplicity, the higher the spectrum efficiency.

Furthermore, when the spectrum efficiency increases, the needed number of signal levels for this invention will not have exponential growth, just linear growth in stead, so the requirement for system linearity can be decreased greatly.

### FIELD OF THE INVENTION

This invention relates to the mobile wireless communication, especially on the method and system of frequency division multiplexing technology.

### BACKGROUND OF THE INVENTION

I. Concept of Spectrum Efficiency and Way to Improve Spectrum Efficiency

The fast development of mobile communications and continuous offering of new services are putting more and more pressure on data transmission velocity. However, the fact is that the frequency resource which can be utilized by mobile communications is very limited. So one urgent problem in mobile communication technology is how to make use of this limited frequency resource to realize high-rate data transmission, and the striking point is how to improve spectrum efficiency.

Spectrum efficiency is referred to as the max (peak value) rate of data transmission supported by each spatial channel in the system, provided the system bandwidth is predefined, the measurement units of which is bps/Hz/Antenna. The concept of spectrum efficiency is further explained in the following instance of a non-spread frequency system.

The bandwidth of a non-spread frequency system is determined by the time duration of its transmission symbol, or the number of symbols transmitted per second, that is symbol rate. Suppose the time duration of the transmission symbol is Ts (in second), which means that the symbol rate is

$$\frac{1}{{T}_{s}} ( symbol \text{/} second ) ,$$

and so determine the system bandwidth is

$$\frac{1 + α}{{T}_{s}} ( Hz ) ,$$

and here α(0<α≦1) is the roll-off coefficient of the system filter. If binary modulation is adopted, such as BPSK, then each symbol carries one bit information. The spectrum efficiency of such a system is

$$\frac{1}{1 + α} bit \text{/} s \text{/} Hz \text{/} Antenna .$$

We can get the implication from the definition of spectrum efficiency that the spectrum efficiency could be improved from two aspects: one is that having one symbol carry as many bits as possible in order to obtain a higher spectrum efficiency under the condition that the bandwidth is the same; another is to promote the spectrum efficiency through compressing the bandwidth by means of frequency overlapping.

Within the current technologies, high-dimensional modulations including QPSK, 8PSK, 32QAM, 64QAM, etc. are corresponding to the first method. However, current technologies corresponding the other way can only perform a half overlapping between the two adjacent and orthogonal sub-carriers, and this is what we call OFDM. Through the following analysis, we can be seen that there exist fatal defects using these two methods to improve spectrum efficiency, so they are not perfect. Fortunately, the present invention of multiple sub-carriers overlapping can overcome the shortages of the above-mentioned methods and can also improve the spectrum efficiency more effectively. The principles and defects of these two methods are described in detail below.

II. High-Dimensional Modulation and its Defects

Suppose M-dimension modulation is deployed, the principle of which is to group Q binary bits to form one of the M symbols (here, M=2^{Q},M≧2). Under this circumstance, each symbol carries Q bits. After that, M symbols are mapped into M signals corresponding to M amplitude levels. Hence modulation of digital signals is completed. Take QPSK for an example: because each symbol can bear 2 bit information, the consequent spectrum efficiency is doubled compared with binary modulation, which is up to

$$\frac{2}{1 + α} bit \text{/} s \text{/} Hz \text{/} Antenna .$$

And for M-dimension modulation, the spectrum frequency is Q times as that of binary modulation, which is

$$\frac{Q}{1 + α} bit \text{/} s \text{/} Hz \text{/} Antenna .$$

There is an underlying flaw with adoption of high-dimensional modulation. With the increase of system spectrum efficiency, as well as amplitude levels, the requirement on channel and transceiver property will become stricter and stricter. For example, the more amplitude levels are used, the stricter request with the linearity of the channel is required. Not only the Am-Am linearity should be extremely good, but also the Am-Pm linearity must be good. While it is well known that an amplifier with better linearity will have lower power efficiency. To guarantee the amplifier's linearity, complex technologies, such as adaptable linear compensation and large-scale power retroversion and so on, must be adopted. In addition, multilevel modulation not only puts demanding requirements on the non-linear distortion of system, but also requires the linear distortion of system harshly. It is known to all engineers and researchers that the transmission function of the ever-changing channel can hardly meet the ideal property expected by the multi-dimensional modulation signals. And any non-ideal linear transmission function of system (amplitude-frequency response and phrase-frequency response) will easily lead to the “eye diagram” merger, after which, even if there is no interference and a better linearity in the system, signals with different amplitude levels can never be distinguished. The higher the transmission rate of information, and meanwhile, the more signal amplitude levels, the easier it is for the “eye diagram” to merge. That's the reason why in high-rate data communication systems utilizing high-dimensional modulation, complicated fast adaptable channel equalization or corresponding information processing and design technologies are deployed without exception to get rid of the merger of “eye diagram”. The above-mentioned problem is particularly serious in a variety of random time-varying channels, such as diverse wireless, mobile, scattering, over-the-horizon, underwater acoustic, atmospheric optical, infrared communications. In these communication channels, the linear transmission functions present random changes with space, frequency and time. On occasions, the speed of this change is so fast that it is often impossible for channel equalization or signal processing technologies to follow. Therefore, high-dimensional modulation with M≧4 is rarely used in all kinds of communication systems applied to random time-varying channel However, it is precisely communication traffic through these channels that emphasize the spectrum efficiency and have higher requirements, as the available spectrum resources are very limited.

The principles of information processing in fundamental information theory tell us that, any preprocessing on the channel linear transmission function \tilde{H}(t,f) will inevitably reduce the theoretical i.e. potential channel capacity. So what we should do is to keep natural. Equalization, as a preprocessing method operated on channel transmission function, will definitely reduce the potential channel capacity to a large extent. As a result, high-dimensional modulation is absolutely not an excellent high spectrum efficiency transmission technology.

III. OFDM and its Defects

(1) Concept of FDM (Frequency Division Multiplexing)

FDM (Frequency Division Multiplexing) is a kind of technology which is aimed at making several narrow banded signals share a wider bandwidth. As shown in FIG. 1, the bandwidth for each multiplexed signal is B1, B2, B3, B4, . . . , distinctly. Of course, they can occupy the same bandwidth. ΔB is the minimum protective bandwidth which can be factually wider. Anyway, ΔB should be larger than the transitional bandwidth of the de-multiplexing filter combined with the maximum system frequency offset plus the maximum diffusing frequency of the channel. This is the most common frequency division multiplexing technology currently. The vast majority of the existing radio, communication and radar systems utilize this technology.

The most important feature of this technology is that the multiplexed signal spectrum is separated from each other, thus interference is avoidable. Besides, there are no restrictions with the multiplexed signals. The spectrum can have different width and shape, and can also be applied to various communication systems, as long as they do not overlap in frequency. So this technology is widely used. But this multiplexing itself has nothing to do with improving the system spectrum efficiency.

(2) OFDM (Orthogonal Frequency Division Multiplexing)

As shown in FIG. 2, OFDM adopts a number of mutually orthogonal sub-carriers, allowing each multiplexed sub-carrier to half overlap another in frequency, that is, there are only two sub-carriers overlapping each other in spectrum. As a result, OFDM is able to provide a spectrum efficiency twice of that of conventional FDM under the same conditions.

The use of OFDM technology to promote spectrum efficiency has its inherent flaws:

In the first place, OFDM can only be applied to digital communications and have demanding requirements on synchronization between multiplexed signals, the same symbol rate, modulation method, and unified spectrum shape, as well as infinitesimal frequency offset. Because of these requirements, it is rarely applied to users' multiplexing, but to parallel transmission of an individual user.

In the second place, working in a random time-varying channel, for the sake of frequency selective fading, the signal spectrum modulated by each sub-carrier must be within the coherent bandwidth of the channel, which also means that they have to present flat fading; otherwise, severe interference between adjacent sub-carriers will occur. As a result, OFDM system can never be a broadband system in a random time-varying channel but degrade to parallel narrowband transmission system under such situation. As it is known that a narrowband system is vulnerable to fading, other assistant technologies such as interleaving and channel coding should be supplemented to ensure the transmission reliability, i.e. the ability to resist fading.

The last but not the least, the spectrum efficiency of OFDM system is finally determined by the amplitude levels of the sub-carrier modulated signals, the improvement of which working in a random time-varying channel is not only difficult but also limited in effect.

IV. A Long-Term Technology Bias

For a long period, it is always believed that increment of mutual overlapping between multiplexed signals spectrum will inevitably result in serious interference between adjacent multiplexed signals, particularly it is considered very hard to restore the transmitted signals at the receiver. The present invention can overcome this long-term technology bias and prove that not only multiple adjacent sub-carriers overlapping can be implemented, but with the increment of overlapping, the spectrum efficiency can be improved.

### SUMMARY OF THE INVENTION

In order to solve the problems of traditional high spectral efficiency techniques such as high level modulation and OFDM, the present invention provides a new method and system of frequency division multiplexing by overlapping different sub carriers. The overlapping would provide some kind of coded bounding between adjacent symbols by mapping a bit sequence to a specific waveform in frequency domain. This would lead to higher spectral efficiency and avoid the difficulties people are facing now in the mobile communications.

The technical details of the invention is as following:

With the transmitter modulating consecutive symbols into overlapped sub carriers, it is natural to damp the received sequence into original symbols according to the mapping strategy.

The number of overlapped subcarriers in a frequency slot is greater than or equal to 3.

The mapping strategy means that the spectral waveform could be obtained through the convolution of data symbol and the overlapped waveform of subcarriers.

The process contains following steps: set the parameters in the modulation according to channel condition and system design; modulate and transmit the signals according to the parameters designed; receive the transmitted signal; demodulate and decode according to the mapping strategy between the data symbol and the modulated signal sequence.

The channel conditions include: the greatest time dispersion Δ or the coherent bandwidth

$${Ω}^{o} = \frac{1}{Δ} ,$$

the greatest frequency dispersion or the coherent time

$${t}^{o} = \frac{1}{{F}^{o}} .$$

System design parameters include: system bandwidth B. Designed parameters of the system include: number of bits per modulated symbol Q, number of amplitude levels M=2^{Q}, length of the modulated symbol sequence Tₛ, bandwidth of the modulated signal B₀, frequency distance between different subcarriers ΔB or number of overlapped subcarriers in a frequency slot K and the number of total subcarriers L; Symbol sequence length Tₛ and greatest time dispersion Δ should satisfy: Tₛ>>Δ.

The process described above is implemented in the frequency domain. Firstly, bit series are transformed bit series into parallel data symbol sequence. Then with the I dimension and Q dimension signal, the first or last subcarrier are duplicated with ΔB gap in the frequency domain, until the pulses of all subcarriers are produced. With those subcarriers multiplied by the parallel data symbols in I and Q dimension and then added together, the modulated waveform of transmitted signals is formed in the frequency domain. Finally, the signals in the time domain could be produced with discrete Fourier transform (DFT).

Receiver of the transmitted complex signal could be designed as following: synchronizing in the symbol level; sampling and quantizing the received signal according to the sampling theorem and then transforming to digital signal series.

The one on one mapping strategy between the received spectral waveform and the transmitted symbol sequence should be set up. Linear transmission function \tilde{H}(t,f) of the practical channel is measured first; calculate the k overlapped spectral waveform Ã_{l-k,k}(f) of each subcarrier with \tilde{H}(t,f) and subcarrier waveform Ã(f); find out the segmented frequency spectrum with the transmitted symbol sequence ũ_{n,l-k} and the spectral waveform Ã_{l-k,k}(f) of the k overlapped subcarriers.

This mapping strategy could be used in the maximum likelihood sequence detection (MLSD) of the received signal, which includes obtaining the segmented frequency spectrum of received signal and implement MLSD for each segment.

To obtain the segmented frequency spectrum contains the following: implement discrete Fourier transform of the received digital signal in time domain to gain the frequency spectrum in each time interval; segment the spectrum with interval ΔB to gain the spectrum for each subcarrier.

MLSD should be implemented for each segmented spectrum. With the number of amplitude levels M=2^{Q}, number of subcarriers in each spectral slot k, the following should be calculated: initial states, final states, pre transition states, post transition states, stable states and the transition relationship between different states. Trellis graph in the frequency domain should be calculated with the total number of sub-carriers L and the transition relationship between states. Then the segmented spectrum of the received signal should be calculated in each state transition branch. Finally, the path with the smallest Euclidean distance or weighted Euclidean distance to the received segmented spectrum in the trellis graph should be searched out as the MLSD result.

The above mentioned states correspond to the K−1 Q-dimension-modulated data symbol sequence, pre-states to those states before which there are smaller than or equal to K−2 Q-dimension-modulated zero data symbols, post-states to those with smaller than or equal to K−2 Q-dimension-modulated zero data symbols after them, initial states to those with all K−1 Q-dimension-modulated symbols as zero before they transit to the pre-transition states, final states to those K−1 Q-dimension-modulated symbols as zero after transition from the post-transition states. Stable states mean those with all K−1 Q-dimension-modulated as non-zero.

Searching in the trellis of the frequency domain should be implemented with the minimum Euclidean distance or minimum weighted Euclidean distance criteria. Set the Euclidean distance of the paths from the initial states as zero; for all the states S in the l^{th} plot, calculate the branch Euclidean distance or the weighted Euclidean distance between the received segmented frequency spectrum and the branches from the previous states to the current states. For each state S, add the branch Euclidean distance or the weighted Euclidean distance to the Euclidean distance or the weighted Euclidean distance of the states where the branches start from. Select the minimum one all the possible transitions into state S as the Euclidean distance or the weighted Euclidean distance for state S in the l^{th} plot and update the original one. Find out the path corresponding to the minimum branch Euclidean distance and update the reserved path for state S. Repeat these steps for the next state and the next plot until (L+K−2)^{th} plot. Check out whether there is same output in the initial part of the paths stored for every state and if there is any, output them and release the corresponding memory space.

The Euclidean distance stored in the memory is the relative distance, which means the distance difference between the current distance and the minimum or the maximum distance. This could be done by setting the minimum or the maximum distance as zero.

A frequency divide multiplex system is made up of digital signal transmitter and digital signal receiver.

Digital signal transmitter includes a complex signal modulator which is used to generate complex signal modulated by overlapped sub-carriers and a signal transmitter to transmit signal. Digital signal receiver includes a signal receiver to receive the complex signal generated by transmitter.

Received signal detector uses the bijection relationship between transmitted digital signal sequence and the spectrum of received signal to detect data sequence.

The “overlapped” mentioned above means the overlap factor should be bigger than or equal to 3.

Complex modulator includes: 1) S/P unit, which changes input serial bit stream into multiple parallel data sequence. 2) Carrier spectrum generator unit, which generates filter spectrum signal of in-phase component I and quadrature component Q of the first or last sub-carrier. 3) Carrier frequency shift unit, which moves filter spectrum signal mentioned above one sub-carrier frequency interval ΔB successively. 4) Multiplying unit, which multiples all carriers generated by carrier spectrum generator unit with parallel data sequences from S/P unit to get the parallel modulated signal sequences. 5) Adder unit, add parallel modulated signal sequences together. 6) Inverse Fourier transformation unit, which convert spectrum signal into time domain signal.

Signal receiver includes: 1) Symbol synchronization module, used to synchronize symbol of received signals in time domain; 2) Digital signal processing unit, used to sample and quantify signal received at each symbol interval, changing it into a digital receiver signal sequence.

Received signal detector includes: 1) Fourier transform unit, used to change time-domain signal received by the signal receiver into frequency domain signal; 2) frequency divide units, which is used to divide the frequency domain signal into frequency intervals having a length of ΔB; 3) Convolution coding unit, be used for the formation of the bijection relationship between received signal spectrum and transmitted signal; 4) data detection unit, used to detect data symbol sequence based on bijection relationship formed by convolution coding unit.

Convolution encoder unit can be further divided into: 1) Channel estimation unit used to measure the linear channel transfer function \tilde{H}(t,f); 2) Tap coefficient unit, used to generate tap coefficient Ã_{l-k,k}(f); 3) Trellis generator unit: used to generate trellis diagram of system in frequency domain; 4) coding output unit: used to generate coding output of each transfer branch according to the coefficient and trellis.

Data detection unit can be further divided into: 1) Survivor path storage unit, used to save survivor paths to the all states in 1-th node. Path Euclidean distance storage unit, used to save the Euclidean distance or weighted Euclidean distance between all survivor paths and received signal interval. 3) Branch Euclidean distance storage unit, used to save the Euclidean distance or weighted Euclidean distance between the metric of transmitting from other states to any states S in 1-th node and the received signal interval. 4) Euclidean distance adder, used to add the Euclidean distance of transmitting from some start state to any state S in 1-th node and the survivor path Euclidean distance of those start states which can transmit to states S together. 5) Euclidean distance comparer, used to compare those value calculated by Euclidean distance adder, find a minimum one and use it to refresh the stored value corresponding to state S. 6) Decision unit, used to check the survivor paths of all states. If they share a same part, then this part is outputted as a decision result, and the memory will be released.

The survivor path storage unit mentioned above only saves relative distance. The state having maximum or minimum path distance or weighted distance now is forced to have a zero distance. And the path distance of other paths is their difference from the zero distance state i.e. relative Euclidean distance.

The present invention has following advantages:

1) A complete new OVFDM is submitted in the present invention,allowing adjacent sub-carriers overlapping with each other. The spectrum efficiency is boosted greatly.

2) The number of electrical levels required by this new OVFDM mechanism grows with spectrum efficiency only at an algebraic rate, not an exponential rate, significantly reducing the linearity requirements.

3) This new OVFDM method has no special requirements on system transmission function, frequency stability. Using of complex adapting channel equalizer and frequency tracker is avoided.

4) Comparing with other techniques, This OVFDM has a lower threshold SNR at same spectrum efficiency and same working conditions. Transmission power is saved. Service radius is increased.

5) The given OVFDM has no special requirements on shape, bandwidth, and frequency stability of the multiplexed signal spectrum. Particularly when working in the time-varying channel, because of using wider multiplexed signal spectrum, Hidden diversity gain is received by the random change of channel. System transmission reliability is improved. The wider multiplexed signal spectrum is, the higher diversity gain and reliability is.

### BRIEF DESCRIPTION OF THE DRAWINGS

For the full understanding of the nature of the present invention, reference should be made to the following detailed descriptions with the accompanying drawings in which;

FIG. 1 is the theory figure of frequency division multiplexing;

FIG. 2 is the theory figure of orthogonal frequency division multiplexing;

FIG. 3 is the diagram of overlapped frequency division multiplexing data combination and the corresponding spectrum shape (K=3);

FIG. 4 is the corresponding spectrum figure of overlapped frequency division multiplexing data combination (K=3);

FIG. 5 is the theory figure of overlapped frequency division multiplexing;

FIG. 6 is the schematic illustration of the received signal's spectrum in the overlapped frequency division multiplexing system (K=3);

FIG. 7 is the model of convolutional coding in the overlapped frequency division multiplexing system's frequency domain;

FIG. 8 is the schematic illustration of the impact of frequency selective channel on the spectrum;

FIG. 9 is the tree figure of input-output relation in the overlapped frequency division multiplexing system's frequency domain;

FIG. 10 is the relation figure of node state transform in the overlapped frequency division multiplexing system;

FIG. 11 is the trellis of overlapped frequency division multiplexing system (K=3; first half part);

FIG. 12 is the trellis of overlapped frequency division multiplexing system (K=3; last half part);

FIG. 13 is the state figure of overlapped frequency division multiplexing system (K=3) (to be brief, didn't draw the final state);

FIG. 14 is the detection's process figure of MLSD algorithm (path×and the unmarked paths means eliminated paths);

FIG. 15 is the schematic illustration of an overlapped frequency division multiplexing spread spectrum (including directly spread or CDMA) system transmitter which achieved in the time domain;

FIG. 16 is the theory figure of overlapped frequency division multiplexing system's digital signal transmitter achieved in time domain;

FIG. 17 is the list of all the stable states of overlapped frequency division multiplexing system;

FIG. 18 is the frame of overlapped frequency division multiplexing system;

FIG. 19 is the frame of complex modulation spectrum generator of digital signal sending devices in the overlapped frequency division multiplexing system;

FIG. 20 is the frame of signal receiver of digital signal receiving devices in the overlapped frequency division multiplexing system;

FIG. 21 is the frame of receiving signal detector of digital signal receiving devices in the overlapped frequency division multiplexing system;

FIG. 22 is the convolutional codling's unit frame of receiving signal detector of digital signal receiving devices in the overlapped frequency division multiplexing system;

FIG. 23 is the data detection's unit frame of receiving signal detector of digital signal receiving devices in the overlapped frequency division multiplexing system;

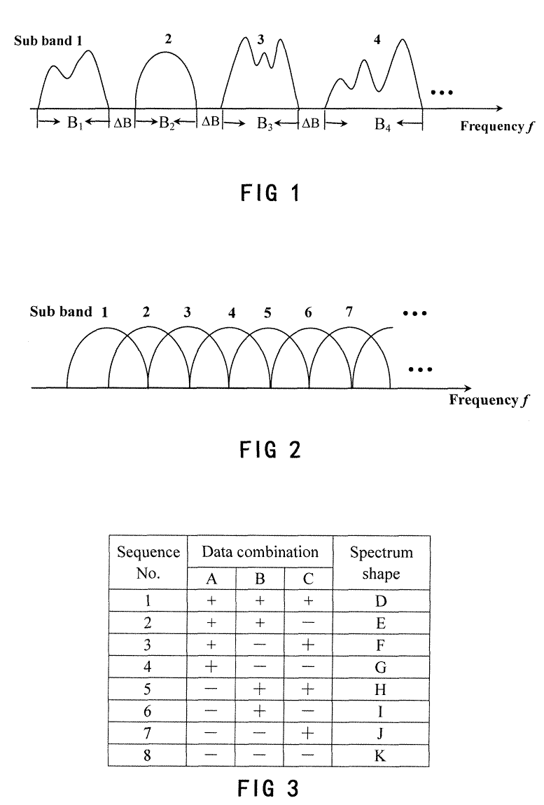

Like reference numerals refer to like parts throughout the several views of the drawings.

### DESCRIPTION OF THE EMBODIMENTS

Basic Theoretical Foundation of the Present Invention

(1) Principles of Overlapped Frequency Division Multiplexing

The present invention is also a frequency multiplexing technique, but its subcarrier spectrum has stronger overlapping than OFDM, so it's called Overlapped Frequency Division Multiplexing or Non-orthogonal Frequency Division Multiplexing. But in the present invention, the spectrum overlapping isn't considered as interference, but can be used actively to form a new coding constraint relation. The more frequency overlapping, the longer coding constraint length, the higher coding gains, the higher frequency efficiency. Under the same signal interference ratio threshold, it can provide higher frequency efficiency than the existing high order modulation techniques; In the same way, under the same frequency efficiency, the needed signal interference ratio threshold is much lower than the high order modulation techniques, especially in the time-varying channel where the improvement would be outstanding. Plus unlike OFDM, the present invention's subcarrier spectrum can be signal with wide spectrum, allowing for selective fading, so it has strong anti-fading capabilities. At last, it should be noted that for the conventional frequency multiplexing FDM, OFDM, the system spectrum efficiency won't be improved by multiplexing itself, but the present invention used multiplexing to greatly improve system's spectrum efficiency.

Take the overlapping of 3 carriers as an example, the detailed description of the principles of overlap frequency division multiplexing will be given.

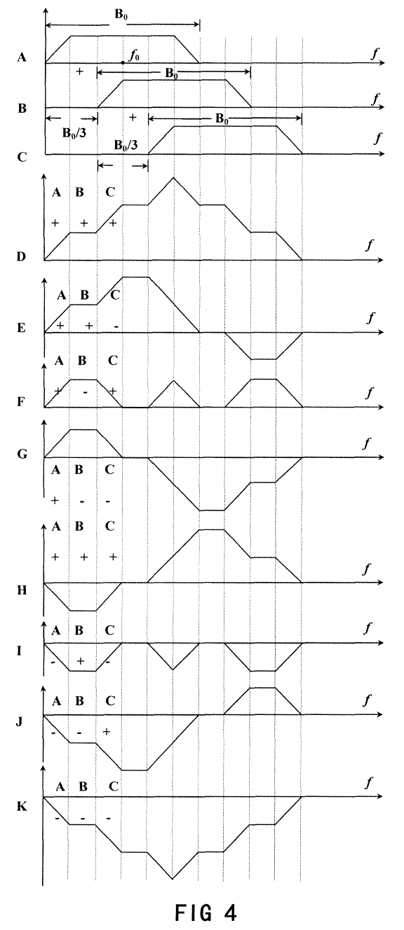

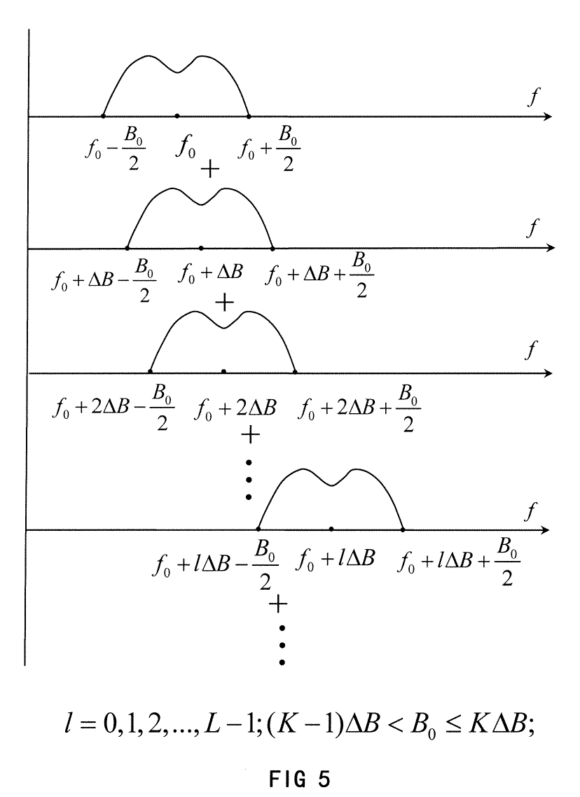

In FIG. 4, the spectrum of the 3 signals are overlapped. As a result of the overlap, if the traditional demodulation is imposed on any of the signals, severe interference will be introduced, so correcting demodulation is impossible using conventional ways. But, the present invention let us revisit the FIG. 4, suppose the spectrums of three multiplexing signals A,B,C are all B₀ Hz, the subcarrier spacing, also known as relative frequency offset, is B₀/3 Hz, that's to say, the spectrums of the three signals are overlapped. For simplicity, suppose the spectrums of A,B,C have identical shapes, their phase characteristics are zero, modulation method is BPSK, symbol length is Tₛ second, all the subcarrier modulated signals' spectrums are B₀ Hz and the three signals are synchronized. Because the three signals are overlapped, each is interfered by adjacent subcarrier signals, the correct demodulation is impossible by using traditional ways. But the present invention doesn't treat the subcarrier signals isolatedly, but consider them in a unified view. Then the situation is different now, the data transmitted by the signals A,B,C correspond to one of the eight situations depicted in FIG. 3.

And the spectrums of the corresponding received signals regardless of noise are respectively the situations of D,E,F,G,H,I,J,K depicted in FIG. 3. The data and the spectrum shape have one-to-one correspondence. In the same way, it can be tested and mathematically proved, to any overlapping order, the data and the spectrum shape also have one-to-one correspondence. Under normal circumstances, if the multiplexing subcarrier spectrum is B₀ Hz, here B₀ has taken into account all the spectrum spread factors (such as system frequency drift, Doppler frequency). In overlap frequency multiplexing, the subcarrier spacing is ΔB Hz, which satisfies: (K−1)ΔB<B₀≦KΔB; K=1, 2, . . . .

It means that there're K adjacent subcarrier spectrum overlapping, every subcarrier transmits the information of M=2^{Q}, namely, every symbol carriers Q=log₂ M bits information. If the system has L such overlapping subcarrier, the transmitted data combination pattern has 2^{QL}=M^{L} items, and the one-to-one correspondent 2^{QL}=M^{L} spectrum shape. So at the receiver, it only needs to decide to which spectrum shape the transmitted data combination pattern corresponds. The frequency overlapping destroys the single transmitting data's spectrum shape, destroys the one-to-one correspondence between data and spectrum shape, but it doesn't destroy the one-to-one correspondence between the data sequence and the spectrum shape. This is the present invention's important theoretical foundation. Of course, when M^{L} is very large, it's an important practical problem of decreasing the complexity. The present invention will give an optimum algorithm to solve the problems, whose complexity is dependent on M^{K}, not M^{L}.

Now let's return to the average circumstances. In FIG. 5, suppose the multiplexing subcarriers' spectrum is B₀ Hz; symbol rate is

$$\frac{1}{{T}_{s}} symbol \text{/s} ;$$

modulation order is M=2^{Q}; bit rate is

$$\frac{Q}{{T}_{s}} bit \text{/s} ;$$

then single subcarrier's spectrum efficiency is

$$\frac{Q}{{B}_{0} {T}_{s}} bit \text{/s/Hz} ;$$

if L subcarriers are adopted, the system spectrum is B₀+(L−1)ΔB, but the overall bit rate is increased to

$$\frac{LQ}{{T}_{s}} bit \text{/s} ,$$

so the spectrum efficiency is:

$$\frac{LQ}{{B}_{0} {T}_{s} + ( L - 1 ) Δ {BT}_{s}} \leq \frac{LQ}{{B}_{0} {T}_{s} ( 1 + \frac{L - 1}{K} ) } = \frac{LKQ}{{B}_{0} {T}_{s} ( K + L - 1 )} {\to }^{L ≫ K} \frac{KQ}{{B}_{0} {T}_{s}}$$

$$and$$

$$\frac{LQ}{{B}_{0} {T}_{s} + ( L - 1 ) Δ {BT}_{s}} > \frac{LQ}{{B}_{0} {T}_{s} ( 1 + \frac{L - 1}{K - 1} ) } = \frac{L ( K - 1 ) Q}{{B}_{0} {T}_{s} ( K - 1 + L - 1 )} {\to }^{L ≫ K} \frac{( K - 1 ) Q}{{B}_{0} {T}_{s}}$$

It can be seen that, when the number of subcarriers is large, L>>K, as the K increased, the spectrum efficiency will increase proportionally, but the system's voltage level numbers won't increase exponentially as the conventional high order modulation, but increase algebraically. For example, when Q=1, the subcarriers use two order modulation, the K overlapping multiplexing system's voltage level number is K+1, only increasing linearly as K, when Q=2, the subcarriers use M=2²=4 order modulation, the K overlapping multiplexing system's voltage level number is K+1 for both in-phase I channel and orthogonal Q channel, the system's overall voltage level number is (K+1)², which is only increasing as K². Obviously when the channel's separable voltage level number is fixed, the spectrum efficiency of the system using the overlap frequency division multiplexing is much higher than high order modulation system. For example, a wireless system under high speed moving conditions uses 64QAM modulation, the voltage level number is M=64, in-phase I and orthogonal Q channel's voltage level numbers are \sqrt{M}=\sqrt{64}=8, but a overlap frequency division system with the same I and Q channel's voltage level numbers has overlap order K=7, its symbols carry 14 bits, but the 64QAM system's symbols carries 6 bits, so its spectrum efficiency is only 3/7 of the overlap frequency division system's. On average, if the existing system uses M-QAM modulation, then under the same voltage level number, the overlap frequency division system using QPSK modulation has overlap order K=\sqrt{M}−1, its spectrum efficiency is

$$\frac{2 ( \sqrt{M} - 1 )}{{log}_{2} M}$$

times more than the M-QAM modulation system's spectrum efficiency.

(2) Mathematics Theory of Overlapped Frequency Division Multiplexing

A: The Transmitted and Received Signal of OVCDM

Assuming that the probability of every symbol is equal and memoryless, the duration of every symbol is TS, the information is transmitted parallel. We assume that there are L subcarriers, and the bandwidth of every subcarries is B0, in order to be simple, we assume that the modulation has the same characteristic of filter complex envelope.

The data transmitted is the following:

Ũ=[ũ₀,ũ₁,ũ₂, . . . ,ũₙ, . . . ] n=0,1,2, . . .

and

ũₙ=[ũ_{n,0},ũ_{n,1}, . . . ,ũ_{n,L-1}]=[(Iₙₒ+jQₙ₀),(Iₙ₁+jQₙ₁), . . . ,(I_{n,L-1}+jQ_{n,L-1})];

ũ_{n,l} [symbol] I_{n,l}+jQ_{n,l}, l=0,1,2, . . . ,L−1; I_{n,l},Q_{n,l} is the symbol transmitted in Lth subcarrier non-orthogonal channel and orthogonal channel. during the nth symbol duration. so the complex signal is just like this:

$$\sqrt{2 {E}_{0}} {\sum }_{n} {\sum }_{l = 0}^{L - 1} {\tilde{u}}_{n , l} \tilde{a} ( t - {nT}_{s} ) {e}^{j 2 π ( {f}_{0} + l Δ B ) t} \\ \tilde{a} ( t ) = 0 , t ∉ [ 0 , {T}_{s} ] , {\int }_{0}^{T} {\vert \tilde{a} ( t ) \vert}^{2} d t = 1 \qquad ( 1 )$$

ã(t) is the normalize modulated complex signal complex, the complex spectrum is Ã(f);

Ã(f)=0,f∉(−B₀/2,B₀/2);

f₀Tₛ>>1 or positive integer;

ΔB is the relative frequency offset, it must follow:

(K−1)ΔB<B₀≦KΔB

E₀: the energy of every symbol∘

B: total system bandwidth

B=B₀+(L−1)ΔB,

Notice: The number of ΔB in B is L+K−1,not L∘

In order to be simple, we will not consider the inter-symbol interference due to the time spread of channel or there is no the time spread of channel, or even though there exists time spread of channel, but the symbol duration is Ts, so the received signal is:

$$\tilde{V} ( t ) = \frac{1}{2} \sqrt{2 {E}_{s}} {\sum }_{n} {\sum }_{l = 0}^{L - 1} {\tilde{u}}_{n , l} \tilde{{a}_{l}} ( t - {nT}_{s} ) exp j \{ 2 π ( {f}_{0} + l Δ B ) t + {φ}_{nl} \} + \tilde{n} ( t ) \qquad ( 2 )$$

ñ(t) is the complex additive Gaussian noise (AWGN), the Power spectral density is N0w/hz,

φₙₗ is phase offset induced by channel,

Eₛ :receive symbol energy, Eₛ=αE₀, α: channel attenuation;

Because the channel is frequency selective, so the received signal maybe different for different subcarriers, we can use ãₗ(t) in equation (2) for different subcarrier, and ãₗ(t)=0,t∉[0,Tₛ],l=0,1, . . . ,L−1;

If the channel is flat fading channel, the ãₗ(t) is same for every subcarrier.

Because there is no inter-symbol in time domain, the inter-symbol only exists in frequency domain, so we don not have to study the whole received sequence, and we only study the symbol received during t ∈[nTₛ,(n+1)Tₛ], so the receive symbol is

\tilde{v}ₙ(t)=\tilde{s}ₙ(t)+ñₙ(t)t∈[nTₛ,(n+1)Tₛ] (3)

and

$${\tilde{s}}_{n} ( t ) = \frac{1}{2} \sqrt{2 {E}_{s}} {\sum }_{l = 0}^{L - 1} {\tilde{u}}_{n , l} \times {\tilde{a}}_{n , l} ( t ) \times exp j \{ 2 π ( {f}_{0} + l Δ B ) t + {φ}_{nl} \} ; \qquad$$

ã_{n,l}(t)=0,t∉[nTₛ,(n+1)Tₛ]; l=0,1, . . . ,L−1; n=0,1, (5)

the spectrum is:

\tilde{V}ₙ(f)=\tilde{S}ₙ(f)+Ñₙ(f), t∈[nTₛ,(n+1)Tₛ] (6)

$${\tilde{S}}_{n} ( f ) = \frac{1}{2} \sqrt{2 {E}_{s}} {\sum }_{l = 0}^{L - 1} {u}_{nl} {\tilde{A}}_{l} ( f ) l = 0 , 1 , 2 , … , L - 1 ; \qquad ( 7 )$$

Ã₁(f) is the spectrum of ã_{n,1}(t)×exp j{2 π(f+lΔB)+φ_{n,l}} and the bandwidth is BO, Ã₁(f)=A(f−f₀−lΔB)×H(t,f) (8)

H(t,f) is the complex Time-varying frequency response function, because the change rate of channel only depends on the speed of physical medium, for example, wind speed, vehicle speed, where in most situations, their speed is much slower than the signal rate, therefore, for most channel, they are slow changing channels, we can assume that during Ts, they are constant, we can use H(t,f) instead of H(t,f), but for different n, A_{n,l}(f) changes according to the change of channel, especially during

$$f ∈ [ {f}_{0} - \frac{{B}_{0}}{2} + l Δ B , {f}_{0} - \frac{{B}_{0}}{2} + ( l + 1 ) Δ B ] ,$$

during the nth of ΔB, the receive complex spectrum is:

$${\tilde{V}}_{nl} ( f ) = \frac{1}{2} \sqrt{2 {E}_{s}} {\sum }_{k = 0}^{Min ( l , K - 1 )} {\tilde{u}}_{n , l - k} {\tilde{A}}_{l , k} ( f ) + {\tilde{N}}_{nl} ( f ) \qquad ( 9 )$$

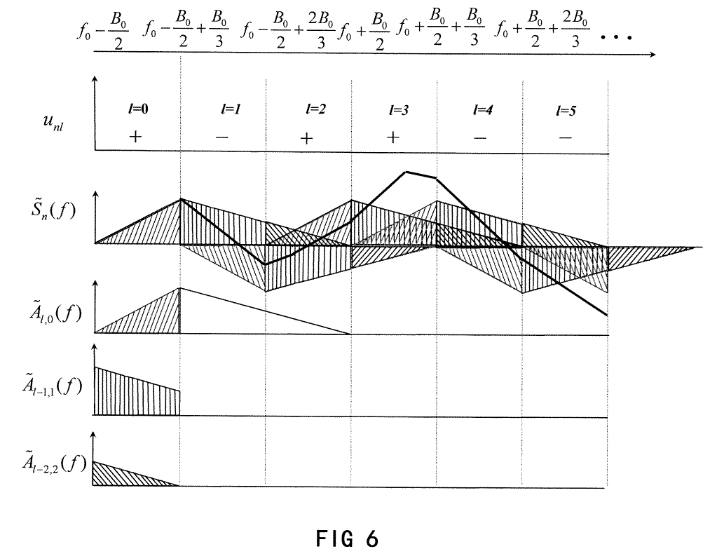

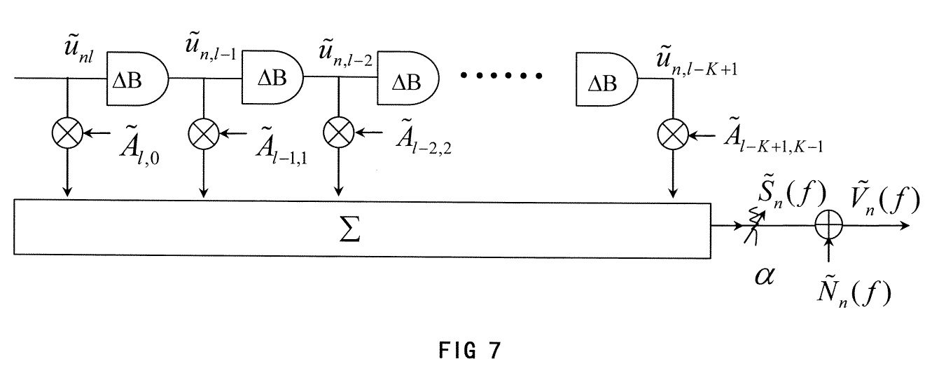

(9) is obviously a function of convolution code, as you can see in FIG. 6 and FIG. 7;

Nₙₗ(f) is constant in the whole range of bandwidth;

$${\tilde{A}}_{l - k , k} ( f ) {=}^{Δ} {\tilde{A}}_{l - k} ( f + k Δ B ) \times [ u ( f ) - u ( f - k Δ B ) ] , \\ l , k ∈ \{ 0 , 12 , … , L + K - 1 \} \qquad ( 10 )$$

1 is different in (9) or (10) from the 1 in all above equations, that is because the whole number of ΔB in the whole range is K−1 more than L, but we should pay attention to this:

when l>L−1,ũ_{n,l}=0; Ãₗ(f)=0;

The following problem is that using MSLD algorithm supplied by the present invention to get the sequence uₙ,n=0,1,2, . . . , and uₙ,n=0,1,2, . . . must minimum the following equation:

$${Min}_{{u}_{n}} {\int }_{B} {‖ {\tilde{V}}_{n} ( f ) - {\tilde{S}}_{n} ( f ) ‖}^{2} d f , \\ B = [ {f}_{0} - \frac{{B}_{0}}{2} , {f}_{0} + \frac{{B}_{0}}{2} + ( L - 1 ) Δ B ] \qquad ( 12 )$$

represents the whole signal bandwidth, ∥∥² is the the square of ;

The mean of equation (12) is just like this: we should find the possible uₙ, so that its spectrum \tilde{S}ₙ(f) is very close to the \tilde{V}ₙ(f) (the Euclidean distance is minimum).

B: Tap coefficient in OVCDM register channel model

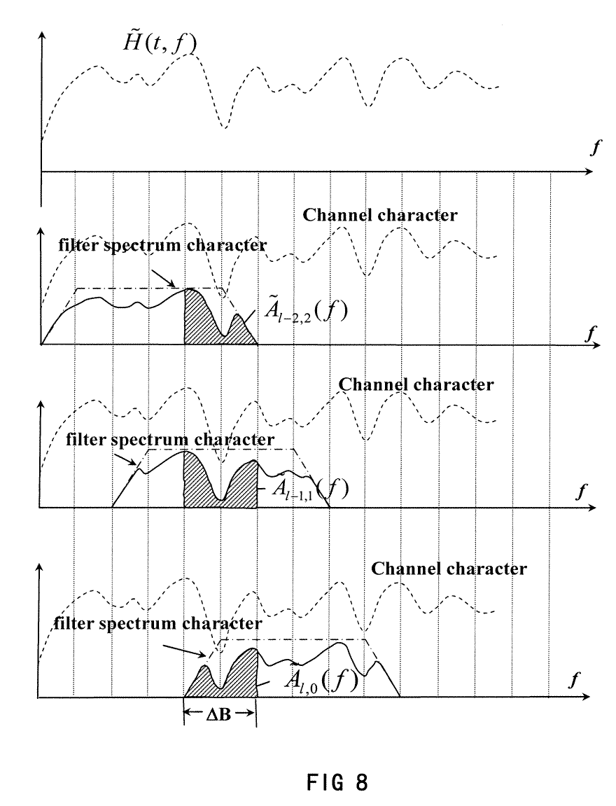

As we all know, in frequency selective channel, \tilde{H}(t,f) does not depend on frequency, it also varies according the observation time, so the shape of \tilde{H}(t,f) may have a difference in some B0, as you can see from FIG. 8. when we employ the convolution operation in frequency domain, all the Tap coefficients are the same if we do not consider the filter effect on modulation signal because they represent the same frequency. But if we take the spectrum characteristic of the signal that is filtered, the Tap coefficients should be the product of the channel response and the spectrum characteristic in the spectrum range of ΔB, as we can see in FIG. 7, when

$$Δ B ≪ {Ω}^{o} = \frac{1}{Δ} ,$$

namely the spectrum offset (the gap between subcarriers)is far less than correlation bandwidth, the coefficients basically depends on the signal spectrum that is filtered, the channel response only acts as an weight factor, when we try to make the signal discrete, the tap coefficients Ã_{l-k,k}(f) will become a numerical value, not a waveform. That can make the realization much more convenient.

3) Tree Diagram, Trellis Diagram and State Diagram of OVCDM System

A. Tree Diagram of OvFDM

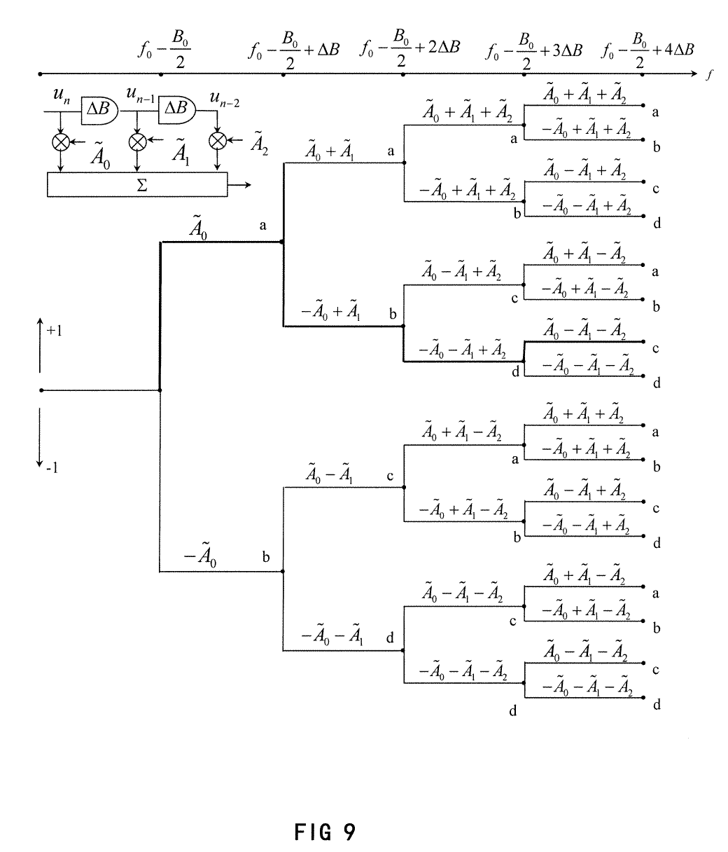

The Tree Diagram of OVCDM is a very image way that expresses the input-output relationship of the frequency domain of OVCDM system. FIG. 9 is a frequency domain's input-output relationship diagram in which K=3, Q=1, which is a binary OVCDM system. In the diagram, the upwards branches represent the input bit uₙ=1, the downwards branches represent the input bit uₙ=−1, and above the branches are the corresponding encoding output. The thick line paths means the input sequence u=[1,−1,−1,1, . . . ]^{T}, and the corresponding complex convolutional coding output are Ã₀, −Ã₀+Ã₁, −Ã₀−Ã₁+Ã₂, Ã₀−Ã₁−Ã₂, . . . . In study of the diagram it will be found that in the frequency domain, the input and output sequences are entirely of one mapping, there must not be one input sequence with two or more output sequences corresponding to, and also the output sequence. Therefore, the frequency spectrum overlapping didn't break the one to one mapping of the frequency domain input and output sequences. So by the sequence detection in frequency domain, it's impossible to see the SEP that can't be reduced any more. Of course the traditional symbol detection should be abandoned. If the sequence length is fixed, for example if the length is L, then the Q dimensions source's sequence amount will be 2^{QL}=M^{L}, and that lead to 2^{QL}=M^{L} dimensions signals' detection. Since in communication it is usually assumed that the sequences are equal probability, so should use the ML detection, and when it's not equal probability, we should use MAP detection. As a result, it seems that the OVCDM system's best signal detection problem has been solved. The theory is true, but it's difficult to achieve, because L is often too big to using ML or MAP directly. People have been in research of convolutional decoding algorithms for decades when inputting sequences are equal probability, and the OVCDM system can be regarded as a complex convolutional encoder in frequency domain, therefore many decoding algorithms of convolutional code, for example the Fano algorithm that searching the best paths (max likelihood function) in tree diagram and all kinds of Stack algorithms, can be mainly used in OVCDM's signal detection after totally innovation. Due to these algorithms are not the truly best ML algorithms, which can only be quasi-best, won't be introduced in the present invention. In the following, we will introduce another algorithm—the maximum likelihood sequence algorithm (MLSD). This is a truly maximum likelihood algorithm, this need to introduce OVCDM system's Trellis Diagram and State Diagram first.

B. Trellis Diagram and State Diagram of OVCDM System

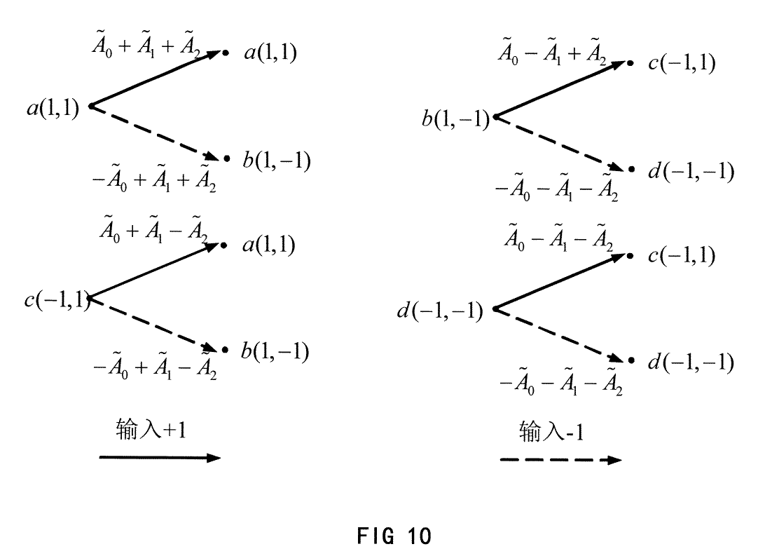

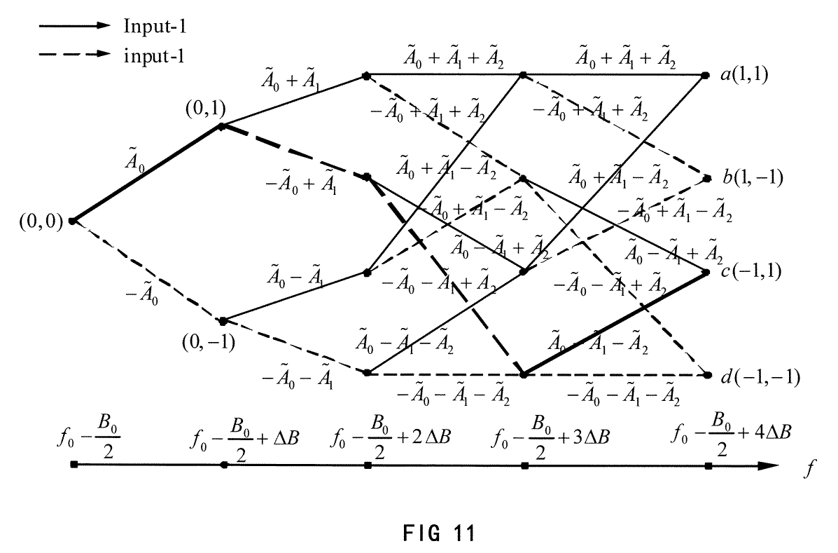

Although the Tree Diagram can describe the relationship of input and output vividly, this diagram is not easy to draw. Especially when the L grows, the diagram will exponentially expand, so it is necessary to be simplified. Back to FIG. 9, it can be found that the Tree Diagram will be repeated after the third branches, because each branch comes from node a has the same output, and it's also to node b, c and d. There are nothing more than a few possibilities, as shown in FIG. 10. From the figure we can see node a can only transfer to (by inputting +1) node a and (by inputting −1) node b, b can only transfer to (by inputting +1) c and (by inputting −1) d, c to (+1) a and (−1) b, d to (+1) c and (−1) d. The cause of this phenomenon is simple, only adjacent K (3 in this case) signals can interfere with each other. Therefore in frequency domain, when the K th data into the channel, the 1^{st} data has been the moved out of the right of the frequency shift unit. So besides of the present frequency data, the channel output depends on the input of the K−1 data before. Generally when M=2^{Q}, which is Q-dimension binary inputting, as long as the front K−1 Q-dimension binary data are same, the corresponding outputs are same. As a result in FIG. 9 (Q=1), after the third branches, each node a can combine together, as same the node b, c and d can combine together, this forms a folded Tree Diagram—Trellis Diagram, as shown in FIG. 11. The solid lines represent the branches inputting +1, and the dotted lines represent the branches inputting −1. This is because after folding it's no longer to order that upwards branch is +1 and downwards branch is −1.

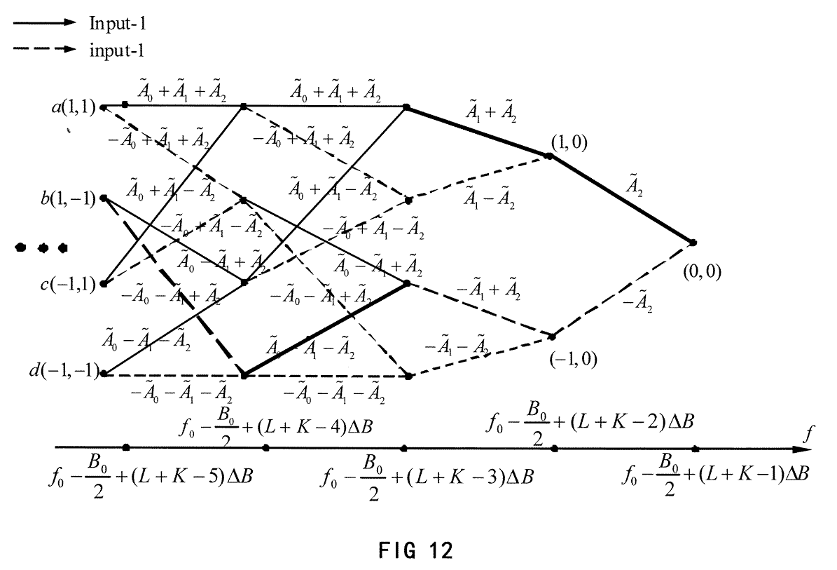

If getting rid of frequency axis's repeated structure of Trellis Diagram, we can get a more simplified diagram—State Diagram. The states of State Diagram depend on Trellis Diagram's nodes, which are the front K−1 Q dimension binary data in channel frequency domain. So in regard to OVCDM system that constraint length is K, the stable state number is 2^{K-1} when binary inputting, 2^{Q(K-1)}=M^{K-1} when Q dimension binary inputting. Besides there are initial and final, pre-transition and post-transition states. In this case initial are final states are both (0,0); pre-transition states are (0,−1) and (0,1), post-transition states are (1,0) and (−1,0). The state transition of initial state and transition state are simple, only make sure that the initial and final state must be all-zero state, and in pre-transition state the data storage in channel contain zeros, and only the new data contain Q dimension binary data + or −, so they can only be transferred from one state, but can transfer to other 2^{Q}=M states (pre-transition state and stable state); post-transition state is opposite to pre-transition state, the data storage in channel contain Q dimension binary data + or −, new data contain zeros, so they can be transferred from other 2^{Q}=M states (pre-transition state and stable state), and can only transfer to one state. Please notice that: in this case, Q=1, K=3, when we are writing a(1,1), b(1,−1), c(−1,1), d(−1,−1) the frequency relationship of each information bit is arranged from left to right, for example in b(1,−1) state 1 is the earliest bit came into channel. But in FIG. 12, Q=1 channel model, the earliest bit that came into channel is storage in the far right frequency shift unit, it is arranged from right to left. Readers please don't confuse about this.

In a result we can see OVCDM is a FSM (Finite State Machine) in frequency domain, its State Diagram can totally describe the channel input-output relationship in frequency domain. Since each state represent the front K−1 Q dimension binary information bits storage in channel, that is, (K−1)*Q bits, and the state transition branches represent the inputting information bits in present frequency. For example, for K=3, Q=1 binary channel the input data are . . . ,−1,1,1, . . . , so in State Diagram, state c will transfer to state a, because c=(−1,1), after inputting 1, the −1 that storage in far right of the frequency shift unit will move out of channel, and the new 1 will move in the channel, so state is transferred to a(1,1), channel output . . . , Ã₀+Ã₁−Ã₂, . . . , which is represent in the branch from c to a.

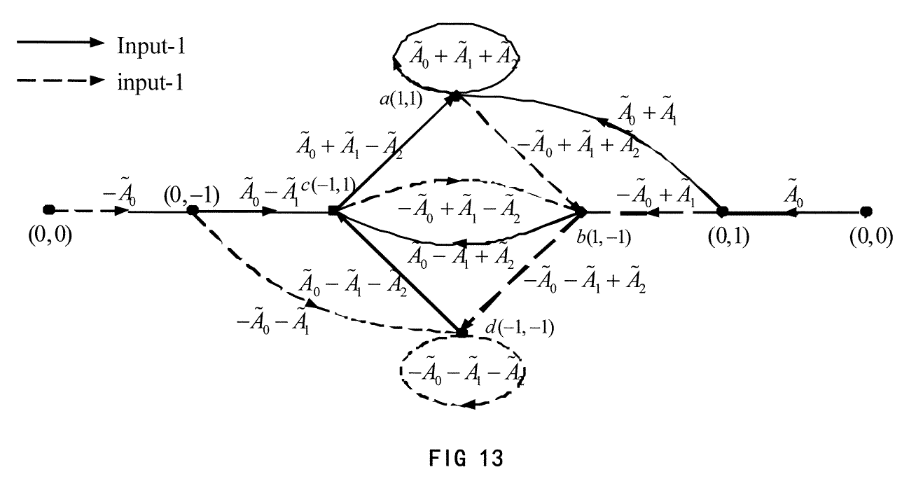

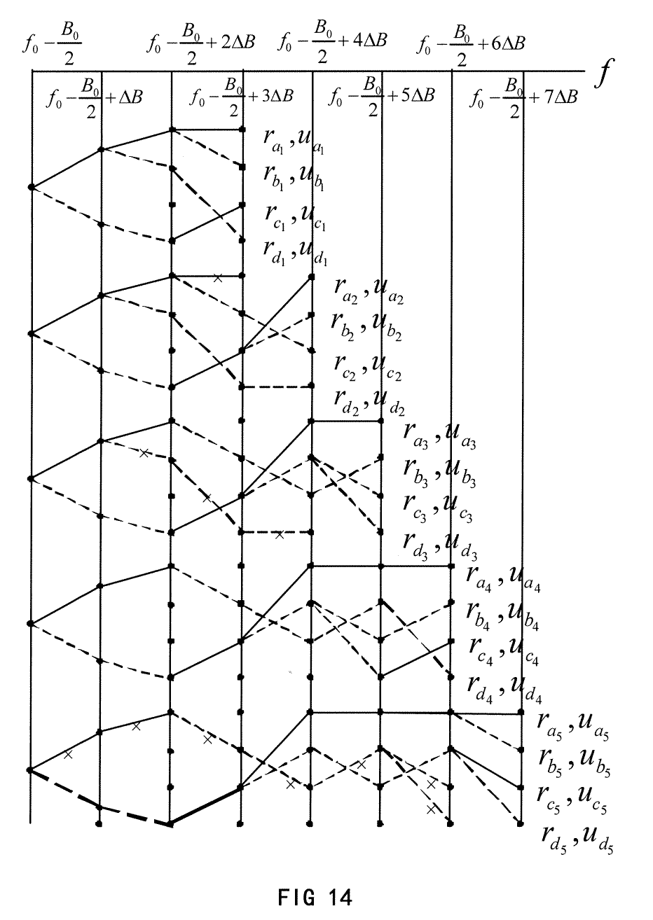

OVCDM system's State Diagram, as shown in FIG. 13, generally for Q dimension binary channel which constraint length is K, its stable state number is 2^{Q(K-1)}=M^{K-1}, and each stable state can transfer to other 2^{Q} states, also can be transferred from other 2^{Q} states. The conclusion in Trellis Diagram will be: constraint length is K, Q dimension binary channel has M^{K-1} different states, in stable situation, each node sends out 2^{Q}=M branches, meanwhile M branches combining in this node.

Trellis Diagram is a very useful tool when research MLSD algorithm.

(4) The Principle of Maximum-Likelihood Sequence Detector in Overlapping Frequency Division Multiplexing

The principle of maximum-likelihood sequence detector in convolutional code can be transformed and transplanted to signal detection in Overlapping Frequency Division Multiplexing system. Underneath we still take GF(2) signal as an example to elaborately introduce MLSD(Maximum Likelihood Sequence Detection) algorithm. We know for Q dimensional input sequence in GF(2) with length L, it probably has 2^{QL}=M^{L} kinds of output sequence (the possible path in Trellis or state diagram). Because L is usually very large, directly adoption of MLSD will become extremely complicated. The substantial of MLSD is Maximum Likelihood algorithm, but its complexity grows exponentially with the channel's memory length K−1, instead of L. So we suppose the noise is white noise, and the input sequence which has maximum likelihood value in white noise channel should have minimum distance with received signal in the tree diagram or the Trellis diagram, that is to say, choose the optimal \tilde{s}ₙ(f) and satisfies

$${Min}_{{u}_{n}} {\int }_{B} {‖ {\tilde{V}}_{n} ( f ) - {\tilde{S}}_{n} ( f ) ‖}^{2} d f ,$$

In the formula:

$$B = [ {f}_{0} - \frac{{B}_{0}}{2} , {f}_{0} + \frac{{B}_{0}}{2} + ( L - 1 ) Δ B ]$$

is the bandwidth of all received signal;

However, because of periodic merger of each path in the Trellis diagram, there is completely no need to calculate the likelihood function or Euclidean distance of the entire path. Because when paths merge, those paths which have a larger Euclidean distance before can be deleted. For example in diagram 11, when

$$t = {f}_{0} - \frac{{B}_{0}}{2} + 3 Δ B ,$$

two paths firstly merge at node a, they respectively are:

Ã₀,Ã₀+Ã₁,Ã₀+Ã₁+Ã₂ (corresponding input sequence is 1,1,1)

and −Ã₀,Ã₀−Ã₁,Ã₀+Ã₁−Ã₂ (corresponding input sequence is −1,1,1)

We respectively calculate the Euclidean distance between this two paths and received signal, obtain a path with relatively smaller distance, called survivor path, at the same time, delete the one with relatively larger distance. Therefore we first store the survivor path of the node a, for example uₐ_{₁}=1,1,1 and the Euclidean distance rₐ_{₁}. It is the same to the node b. They are: Ã₀,Ã₀+Ã₁,−Ã₀+Ã₁+Ã₂ (corresponding input sequence is 1,1,−1) and −Ã₀,Ã₀−Ã₁,−Ã₀+Ã₁−Ã₂ (corresponding input sequence is −1,1,−1) respectively.

We choose one path which has comparatively minimal distance with received signal, and write down the survivor path, for example u_{b}_{₁}=1,1,−1 and the Euclidean distance r_{b}_{₁}. The same processing should be made on the node c and d, result listed in diagram 14, in which all the survivor paths are relatively minimal distance path. Hence we get relatively optimal path and corresponding Euclidean distance of the node a, b, c, d:

rₐ_{₁}′uₐ_{₁}=(1,1,1)

r_{b}_{₁}′u_{b}_{₁}=(1,1,−1)

r_{c}_{₁}′u_{c}_{₁}=(−1,−1,1)

r_{d}_{₁}′u_{d}_{₁}=(1,−1,−1)

At this stage we are not easy to make a decision. Let

$$f = {f}_{0} - \frac{{B}_{0}}{2} + 4 Δ B ,$$

we calculate the Euclidean distance between each node's different path and received signal, and choose the relatively smaller one. For example as for node a, when

$$f = {f}_{0} - \frac{{B}_{0}}{2} + 4 Δ B ,$$

there are four paths arriving in the original Trellis diagram, namely 1,1,1,1; 1,−1,1,1; −1,1,1,1; −1,−1,1,1. But in the first stage of the calculation, the previous three parts of the second and third path have already been eliminated, so we can only make a choice between the first and the fourth path. Hence we should calculate the Euclidean distance respectively. Notice that we do not need to calculate the whole Euclidean distance now because it is the white noise, we only have to compute the Euclidean distance between the path of the node a from

$$f = {f}_{0} - \frac{{B}_{0}}{2} + 3 Δ B to f = {f}_{0} - \frac{{B}_{0}}{2} + 4 Δ B$$

and received signal, adding rₐ_{₁} will make up the first Euclidean distance. Similarly, we can have the fourth Euclidean distance. The path with relatively larger distance is deleted and the smaller distance path rₐ_{₂} with its Euclidean distance uₐ_{₂} are stored. Certainly, rₐ_{₁} and uₐ_{₁} can be eliminated from the storage. We can also carry on the same processing on the node b, c and d. Like this, at each stage l(l=0,1,2, . . . ,L−K+1), as to the nodes' corresponding state (namely the nodes of the l stage in the Trellis diagram), we only store one path which has comparatively minimal Euclidean distance together with its corresponding path.

Diagram 14 is an illustration of the detection process. At the fifth stage of the calculation, namely

$$f = {f}_{0} - \frac{{B}_{0}}{2} + 7 Δ B ,$$

survivor paths (the relatively optimal path) are respectively:

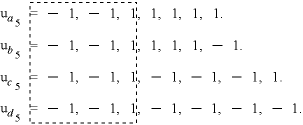

Then the beginning parts of all the relatively optimal paths are −1,−1,1. Therefore we can make a decision:

\hat{u}₀=−1, \hat{u}₁=−1, \hat{u}₂=1.

Naturally they are the optimal path.

If every survivor path has no common beginning parts, calculation will continue on until they had one. Therefore MLSD algorithm is random, it probably has no decision for a long time, and the output may not be symbol by symbol, probably once only have a output, also probably have many outputs at a time, but the largest delay is the length of Trellis diagram L+K−1. It is because in the multi-carrier system with L sub-carriers and K adjacent sub-carriers overlapped with each other in the frequency area, the Trellis diagram's length is L+K−1 at most, and its eventual state is all zero (0,0, . . . ,0), and every path will merge together at last, so the largest delay of MLSD is L+K−1.

Because of the characteristics of MLSD, two problems underlying will emerge:

i) Because MLSD has an output after all the survivor paths have the common initial parts, then decision has a random delay. So the output may have a problem that decision delay is ∞ when L→∞.

ii) MLSD algorithm request two storage at each state, one for saving Euclidean Distance of the relatively optimal path arriving at the state, another for the relatively optimal path. Then how large of the storage capacity is the second problem.

For the first problem, the probability that the decision delay is ∞ has been proved zero in L→∞ system.

For the second problem, first of all, namely Euclidean Distance storage, generally speaking with the existence of noise, the distance is larger and larger between every path and the received signal, so it seems that the storage capacity will become ∞. But because our interested is just their relative distance, so we can let the maximum(or minimum) distance zero, then each survivor path subtract the maximum(or minimum) distance. So, we only store the relative value, and its capacity is limited. Secondly, namely survivor path storage, it is common to take the length of 5K or 4K, because the probability that the length of the survivor path is more than 5K can be neglected. At this time if the storage is full and there is no result, we make a forced decision, that is to say, the beginning of the minimum distance is the decision output. Sometimes we can also adopt the law of the large logic, namely the optimal output is the majority of the survivor path's beginning parts. The equipments of the latter is easy but function slightly worse than the first mode, however because of the probability of forced decision is very small, the function loss is tiny.

The above listed is different from any other communication technology, and we should deal with the signal detection of the overlapped frequency division multiplexing system in the frequency area. This demands the receiver to carry on Fourier Transform (FT), Discrete Fourier Transform (DFT) or Fast Fourier Transform (FFT) to the received signal firstly, then the whole operation proceed in the frequency area. It usually makes many complicated problems easier in the frequency area than in the time area, such as filter operation etc. People are widespread think the overlapped frequency would produce serious mutual interference, but in fact it not only hardly produce interference, on the contrary it is a useful code constraint relation, the more overlapped frequency, and the longer code constraint, we have more coding gain. Of course, this kind of code is a nature coding relation, uncertainly the optimal coding constraint relation. But overlapped frequency division multiplexing with suitable code would further improve system performance.

Theories and the computer simulation verify: In random time-varying channel, for fixed frequency shift (sub-carrier interval) ΔB, we can increase overlapped number K by widening sub-carrier's bandwidth B0, and along with the increase of K, system performance and transmit reliability is better and better. When K→∞, the random time-varying channel can be changed into parameter constant additive white Gauss channel, namely AWGN channel. Therefore in random time-varying channel, as long as the system linearity and transmit power have guarantee, system frequency rate and transmit reliability will increase significantly with the increase of the basic modulation signal's bandwidth and overlapped frequency number K. Certainly complexity of the system would also immediately increase.

The Concrete Implement of this Invention

Implementation 1

This Implement provides a method of Overlap Frequency Division Multiplex. The follows are specific step:

Step 1: According to the given channel parameter and system parameter, decide some basic design parameter:

Channel parameter: Channel maximum time dispersion: Δ (second), or coherence bandwidth

$${Ω}^{o} = \frac{1}{Δ} ( Hz ) ;$$

Channel maximum frequency dispersion [symbol] (Hz) or Channel coherence time

$${t}^{o} = \frac{1}{{F}^{o}} ( second ) ;$$

System parameter: System bandwidth B (Hz); the requirement about Spectrum Effectiveness; linear degree, and so on.

Design parameter:

Number of basic modulation level M=2^{Q}; where Q means the number of carrier information bits per modulation symbol. According to the condition that in the same spectrum effectiveness, the complexity of system has nothing to do with M, it could be selected through concrete condition;

Basic symbol length Tₛ (second), basic modulation symbol spectrum width B₀ (Hz);

In order to reduce the complexity, the present invention suggests TₛΔ;

Select larger B₀ and longer Tₛ, then it will automatic generate diversity gain, and improve the performance of system.

Implicit frequency diversity multiplicity K_{f}⁰=[B₀Δ+1];

Implicit time diversity multiplicity Kₜ⁰=└ [symbol] Tₛ+1┘;

where └ ┘ means the minimum positive integer greater than.

Relativity frequency shift (interval of sub-carrier) ΔB or frequency overlaps multiplicity K:

Minor ΔB and larger K will improve the spectrum effectiveness of system, but it will cause the complexity and increase the number of permission levels. So it is need to be decided through the reality condition. The basic relationship as follows:

(K−1)ΔB<B₀≦KΔB

Where B₀ should not only include the bandwidth of basic modulation signal, but also should include the system maximum frequency shift and maximum Doppler frequency dispersion, and some other factor of frequency dispersion.

In the condition that ΔB are much minor than channel coherence width

$${Ω}^{o} = \frac{1}{Δ} ,$$

the shift tap coefficient channel model of Overlap Frequency Division system Ã_{l,k}(f) will convergence to be the example value after modulation signal filter, and the response of channel in this frequency point only to be used as a weighted factor. In contrast with, the shift tap coefficient Ã_{l,k}(f) in channel model of Overlap Frequency Division Multiplex system will be some frequency waves.

Total number of system sub-carrier L

According to the system bandwidth B=B₀+(L−1)ΔB, and then

$$L = \frac{B - {B}_{0}}{Δ B} + 1 ;$$

At the moment of deciding channel parameter, the design parameter B₀,ΔB,K,L is tightly integrated with each other, so it is need to be selected repetitively and optimal designed through the reality condition.

System spectrum effectiveness η:

$$η = \frac{L Q}{{B}_{0} {T}_{s} + ( L - 1 ) Δ B {T}_{s}}$$

In the condition K is given, the minor ΔB and B₀ will lead to a larger L and a higher η, but a excess large L will increase the requirement of system's linear degree;

And the excess minor B₀ will leads system's natural implicit diversity multiplicity K_{f}⁰=└B₀Δ+1┘ decrease. But it is no use to consider it in the condition that the system bandwidth B is wide enough. Because we can increase the implicit frequency diversity multiplicity through some technical method such as interleave and coding. Because for the system, its implicit diversity multiplicity is decided by └BΔ+1┘, but not [B₀Δ+1┘. The different between this two is that the later one are generated naturally, and the former one is archived through technical method.

When the spectrum width and number of modulation levels of each sub-carrier modulation signal become different, the condition will be more complexity. But it is totally possible to select parameter and design through the above formula and method.

Step 2: Use the given channel characteristic, system parameter and design parameter, design the transmit system of Overlap Frequency Division Multiplex.

Because of the same as some multi-carrier system such as OFDM, the Overlap Frequency Division Multiplex tech is also a parallel multi-carrier synchronous data transport system. The different is the method modulation and detection are totally different, but its transmit machine is same as tradition one.

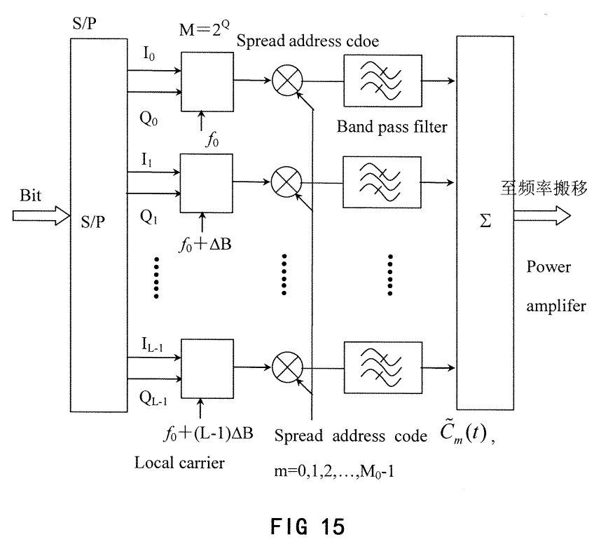

FIG. 15 is a general view of Overlap Frequency Division Multiplex spread frequency (include the direct spread or CDMA) system implemented in time domain. For the non-spread frequency or CDMA, the operation part of spread frequency could be cut off. The complex operation of transmit implemented in the number n (n=0, 1, 2, . . . ) symbol time zone is:

$$\sqrt{2 {E}_{0}} {\sum }_{l = 0}^{L - 1} {\tilde{u}}_{n , l} \tilde{a} ( t ) {e}^{j 2 π ( {f}_{0} + l Δ B ) t} , t ∈ [ n {T}_{s} , ( n + 1 ) {T}_{s} ] \qquad ( 13 )$$

Where E₀ means transmit power per symbol, ã(t) means generalization of envelope of complex modulation signal. It meets the following condition:

\tilde{a}(t)=0, t∉[nTₛ,(n+1)Tₛ]

∫_{nT}_{ₛ}^{(n+1)T}^{ₛ}|ã(t)|²dt=1, n=0,1,2, . . .

ũ_{n,l}=I_{n,l}+jQ_{n,l} is the complex data transported by the number l(l=0,1, . . . ,L−1) sub-carrier.

Its counterpart operation in frequency domain is:

$$\sqrt{2 {E}_{0}} {\sum }_{l = 0}^{L - 1} {\tilde{u}}_{n , l} \tilde{A} ( f - {f}_{0} - l Δ B ) \qquad ( 14 )$$

Where Ã(f) is the spectrum of complex basic modulation signal Ã(f), and its bandwidth is B₀ Hz, i.e.

$$\tilde{A} ( f ) = 0 , f ∉ [ - \frac{{B}_{0}}{2} , \frac{{B}_{0}}{2} ]$$

Ã(f−f₀−lΔB) means the each sub-carrier's spectrum, each central frequency is f₀+lΔB (l=0,1,2, . . . ,L−1), all sub-carrier's bandwidth is B₀, i.e.

$$\tilde{A} ( f - {f}_{0} - l Δ B ) = 0 ; f ∉ [ {f}_{0} - \frac{{B}_{0}}{2} + l Δ B , {f}_{0} + \frac{{B}_{0}}{2} + l Δ B ]$$

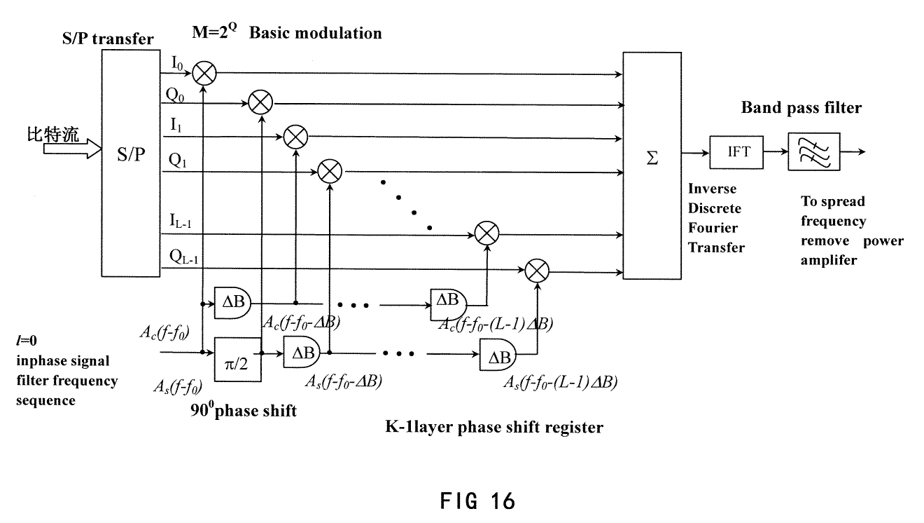

In engineering, the structure of FIG. 15 is hard to assure the operation in frequency is same as Equation 14. It is caused by the structure of this L filters. Because of the different of each central frequency, it is hard to guaranty their consistency of envelope, and this consistency will take a great convention in the design of receive machine. For this reason, it can be changed to implement in frequency domain. FIG. 16 is the basic structure diagram about this implementation.

The basic point of this figure is that it use digital method to generate the in-phase component A_{c}(f−f₀) sequence of the number l=0 path complex modulation signal filter spectrum Ã(f−f₀)=A_{c}(f−f₀)+jAₛ(f−f₀). A_{c}(f−f₀) sequence's

$${90}^{0} ( \frac{π}{2} )$$

phase position shift is the orthogonal component of Ã(f−f₀), i.e. sequence Aₛ(f−f₀). They will get the other l=1,2, . . . ,L−1 path's complex modulation signal through the shift register in frequency domain. The filter operation in frequency domain is very simple, and the shift operation is also simple, it guarantees the consistency of the envelope of each path signal.

Step 3: Generate the symbol time synchronous in receive machine. In the synchronous condition, the receive signal for every symbol time zone t ∈[nTₛ,(n+1)Tₛ],n=0,1,2, . . . generate the complex receive signal spectrum sequence \tilde{V}ₙ(f), the follows are sub step:

According to the Sample Theorem, select suitable sample frequency, and use digitalization to receive signal, to generate the digital sequence of receive signal in time domain. Digitalization could be in middle frequency, and also could be preceded in baseband, which can be decided by designer.

Carry on Fourier Translate or Discrete Fourier Translate (include FFT) to the time domain digital sequence of receive signal. In the condition of time synchronous, generate the time piecewise receive signal spectrum \tilde{V}ₙ(f), t ∈[nTₛ,(n+1)Tₛ],n=0,1,2, . . . for every symbol's time duration [nTₛ≦t<(n+1)Tₛ,n=0,1,2, . . . .

Carry on frequency piecewise to \tilde{V}ₙ(f) in frequency axis, width of each segment is ΔB, i.e. [\tilde{V}_{n,0}(f),\tilde{V}_{n,1}(f), . . . ,\tilde{V}_{n,L+K-1}(f)]

Where the number l(l=0,1,2, . . . ,L+K−1) segment spectrum is:

$${\tilde{V}}_{n , l} ( f ) {=}^{Δ} {\tilde{V}}_{n} ( f ) \times [ u ( f - {f}_{0} + \frac{{B}_{0}}{2} - l Δ B ) - u ( f - {f}_{0} + \frac{{B}_{0}}{2} - ( l + 1 ) Δ B ) ] ;$$

u(f) is the unit step function in frequency domain;

$$u ( f ) = \{ \begin{matrix}1 & f > 0 \\ \frac{1}{2} & f = 0 \\ - 1 & f < 0 ;\end{matrix} \\ l = 0 , 1 , 2 , … , L + K - 1.$$

It is because of there are L+K segments separated by ΔB in total bandwidth.

Step 4: Carry on measurement to the actual channel, and find estimation \tilde{Ĥ}(t,f),t ∈[nTₛ,(n+1)Tₛ],n=0,1,2, . . . of the linear transport function \tilde{H}(t,f) in different symbol time zone.

It can be used in every method to estimate transport function, such as the measurement used by pilot signal, or use the decision information to estimate through the method of received signal operation, even can use the blind estimation.

Step 5: Utilize \tilde{Ĥ}(t,f) found by step 4 and the spectrum Ã(f) of known modulated signal ã(t) to generate the tap coefficient of Overlap Frequency Division

Multiplex system in frequency domain channel model.

Where: Ã(f)=0,

$$f ∉ [ - \frac{{B}_{0}}{2} , \frac{{B}_{0}}{2} ]$$

According to the path coding frequency spectrum of complex received signal in frequency domain

$$f ∈ [ {f}_{0} - \frac{{B}_{0}}{2} + l Δ B , {f}_{0} - \frac{{B}_{0}}{2} + ( l + 1 ) Δ B ] ,$$

the complex spectrum of received signal component in non-noise condition is:

$${\tilde{S}}_{l , S , m} ( f ) {=}^{Δ} \frac{1}{2} \sqrt{2 {E}_{s}} {\sum }_{k = 0}^{Min ( l , K - 1 )} {\tilde{u}}_{n , l - k} {\tilde{A}}_{l - k , k} ( f ) \\ t ∈ [ {nT}_{s} , ( n + 1 ) {T}_{s} ] \\ l , k = 0 , 1 , 2 , … , L - K + 1 ; \qquad ( 15 )$$

This is the complex convolution coding output of different state s, different path m and number l node in trellis of channel model.

Where: Eₛ means power of receive symbol.

ũ_{n,l} means the number l sub-carrier's complex transport data in t ∈[nTₛ,(n+1)Tₛ].

The tap coefficient is: \tilde{A}_{l-k,k}(f)=\tilde{A}ₗ₋ₖ×[u(f)−u(f−kΔB)f)] (16)

l,k=0,1,2, . . . ,L+K−1_{∘}

$$u ( f ) {=}^{Δ} \{ \begin{matrix}1 & f > 0 \\ \frac{1}{2} & f = 0 \\ - 1 & f < 0\end{matrix}$$

is unit step function in frequency domain

\tilde{A}ₗ(f) [symbol] \tilde{A}(f−f₀+lΔB)×\tilde{H}(t,f) (17)

is the received modulation signal spectrum of number l(l=0,1,2, . . . ,L−1) sub-carrier.

Step 6: According to the basic modulation level M=2^{Q} and frequency overlap multiplicity K adopted by system, find all state of system. The state includes five states: initial and terminate state, forward-transitional state, backward-transitional state and steady state. The state S means the Q dimension binary data (+/−) or 0 data corresponding to the modulation data [ũ_{n,l-1},ũ_{n,l-2}, . . . ,ũ_{n,l-K+1}] stored in frequency shift register channel model. Where e,otl u_{n,l}≡0,∀l>L−1;

Both initial and last state have only one same state, they are

$${\underbrace{[ \overbrace{00 … 0}^{Q ↑} , \overbrace{00 … 0}^{Q ↑} , … , \overbrace{00 … 0}^{Q ↑} ]}}_{K - 1 multiplicity}$$

(means 0 state which all Q dimension data are 0)

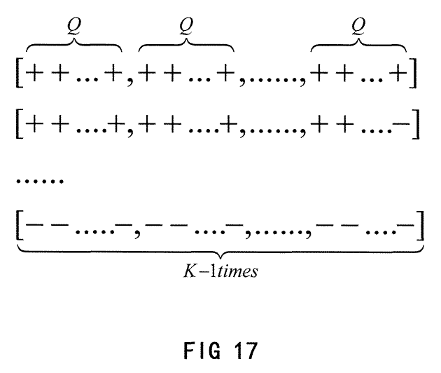

The steady state have Q^{K-1} states, as FIG. 17, they are: (means state which all Q dimension data are binary (+/−) data) Both the forward-transitional state and backward-transitional state have M+M²+M³+ . . .+M^{K-2} states.

Forward-Transitional state means the state which some (but less than K−2) former Q-dimension data are 0.

Backward-Transitional state means the state which next some (but less than 2) Q dimension data are 0.

The initial state could only transfer to 2^{Q} forward-transitional states, and could direct transfer to 2^{Q} steady state when K=2.

The terminate state could only transfer from 2^{Q} backward-transitional states ahead, and could transfer direct from 2^{Q} steady states when K=2;

Forward-transitional could only transfer from the former one state (initial state or forward-transitional), and could transfer to the next 2^{Q} states (forward-transitional state or steady state); forward-transitional state only exist in node l<K−1 of Trellis.

Backward-transitional state could transfer from 2^{Q} states former (forward-transitional state of steady state), and could transfer to next one state (backward-transitional state or the terminal transitional state); backward-transitional state only exist in node l>L−1 of Trellis.

According to it always have a new Q dimension binary data or 0 data enter channel model, at the same time the number K−1 Q dimension binary or 0 old data exit channel model, and Q dimension binary data has 2^{Q} combinations compared that Q dimension data has only one possible, therefore the above relationship of transfer will be happen.

The transitional state is characteristic of Overlap Frequency Division Multiplex, and is the different from the limited state machine corresponding to ordinary convolution code and Trellis code.

Step 7: according to the relationship of state transfer, generate the system's state diagram, Trellis diagram and tree diagram, and them calculate the coding output \tilde{S}_{l,S,m}(f) of each transfer path through the relationship of transfer and Equation 15 in Step 5:

$${\tilde{S}}_{l , s , m} ( f ) = \frac{1}{2} \sqrt{2 {E}_{s}} {\sum }_{k = 0}^{Min ( l , K - 1 )} {\tilde{u}}_{n , l - k} {\tilde{A}}_{l - k , k} ( f ) \qquad ( 18 )$$

Where: l ∈(0,1,2, . . . ,L−K+1) means the number l sub-carrier frequency of input, but ũ_{n,l}≡0 when l>L−1;

S means the state that transfer path arrived in number l node;

m means the path arrived to this state. For the forward-transitional state m=1, and for others, m=2^{Q}=M.

Because of Trellis diagram terminate in node L−K+1, the l in Equation 18 could greater than L−1, but the Trellis diagram must convergence in all zero state in node L−K+1.

Step 8: Prepare two storages for every steady state S, one storage store the reserve path U_{S,l}=[u_{S,0},u_{S,1}, . . . ,u_{S,l], l=}0,1, . . . ,L+K−1 arrived to this state S, where u_{S,l} is Q dimension binary data; the other one store the Euclidean Distance d_{S,l}, (l=0,1,2, . . . ,L−K+1). This distance is between the coding output node corresponding to this reserve path U_{S,l} before number l and the received signal frequency sequence

\tilde{V}ₙ(f)=[e,otl V_{n,0}(f),\tilde{V}_{n,1}(f), . . . ,\tilde{V}_{n,L+K-1}(f)]

It can use every storage of steady state for the transitional state. According to there are M^{K-1} kinds of steady state, therefore every kinds of storage need M^{K-1} ones, so the total number of storage needed is 2M^{K-1}.

Step 9: Carry on Maximum Likelihood Sequence Detection MLSD, and the sub step are follows:

Make the Euclidean Distance of the path of initial node state (l=0) is d_{0,0}=0.

Calculate all m(m=1 or 2^{Q}=M) paths' Euclid Distance d_{S,m}(l,l+1), which between coding signal transferred to this state from former state and receive signal frequency sequence \tilde{V}n,l(f), for all the state of node l(l=1, . . . ,L−K+1).

For every state S, sum the Euclidean Distance d_{S,m}(l,l+1) arrived to this state and the Euclidean Distance d_{S′,l-1}of their start state S′, to generate new m ones of Euclidean Distance. And then choose the minimum one as the Euclidean Distance d_{S,l} of the node l and state S, then update and store it into Euclidean Distance storage of this state S.

$${d}_{S , m} ( l , l + 1 ) {=}^{Δ} {\int }_{{f}_{0} - \frac{{B}_{0}}{2} + l Δ B}^{{f}_{0} - \frac{{B}_{0}}{2} + ( l + 1 ) Δ B} {\vert {\tilde{V}}_{n , l} ( f ) - {\tilde{S}}_{l , S , m} ( f ) \vert}^{2} d f \qquad ( 19 )$$

Find the reserve path U_{S,l} corresponding to each Euclidean Distance for every state in node l(l=1,2, . . . ,L−K+1), then update and store it into storage of reserve path.

Repeat Step 2, 3, 4 for node l+1, until to the node l=L+K−2. And then, the reserve path remains only one. The date corresponding to this reserve path is the terminal detection output which we need.

In the condition than the number of sub-carrier L is larger, in order to use a shorter storage of reserve path, its length could be 4K˜5K, in this condition it can check reserve path storage of all state in step 4, when the same initial part of all reserve path is found, make this same part as the decision output, and them clear the space of storage at the same time.

In order to reduce capacity of Euclidean Distance storage of all state S, and avoid overflow, can make the one which Euclidean Distance is greatest (or least) as 0 distance when each step are completed, and Euclidean Distance storage of other states only store the difference (positive or negative)of it, i.e. relatively distance.

Step 10: In the condition that the frequency overlap multiplicity K excess large, although step 9 has the optimal performance, i.e. it can find the real path which has the minimum Euclidean Distance with received signal in frequency domain, but it will lead complexity to sequence detector for the excess large K in step 9. In order to reduce the complexity, it can use the experience of the other fast sequence detection algorithm in convolution code. The substance still work in frequency, and the different is the selected one have the relativity minimum Euclidean Distance with received signal. All method to reduce the system's complexity has their costs that scarify the system's threshold of SINR.

The above Implement take the sub-carrier with same frequency width as example to describe the concrete implement method of Overlap Frequency Division Multiplex, and there is no specific requirement of the spectrum of multiplex signal in Overlap Frequency Division Multiplex. The shape and width of signal spectrum in different sub-carrier could be same, and also could be different; the interval of sub-carrier frequency is fixed. For the realization of sequence detector in receiver, it should restrain the maximum bandwidth which can be marked as Bₒₘₐₓ in each sub-carrier, and can be substituted for B₀ to calculate spectrum effectiveness, number of states, and so on.

Implementation 2:

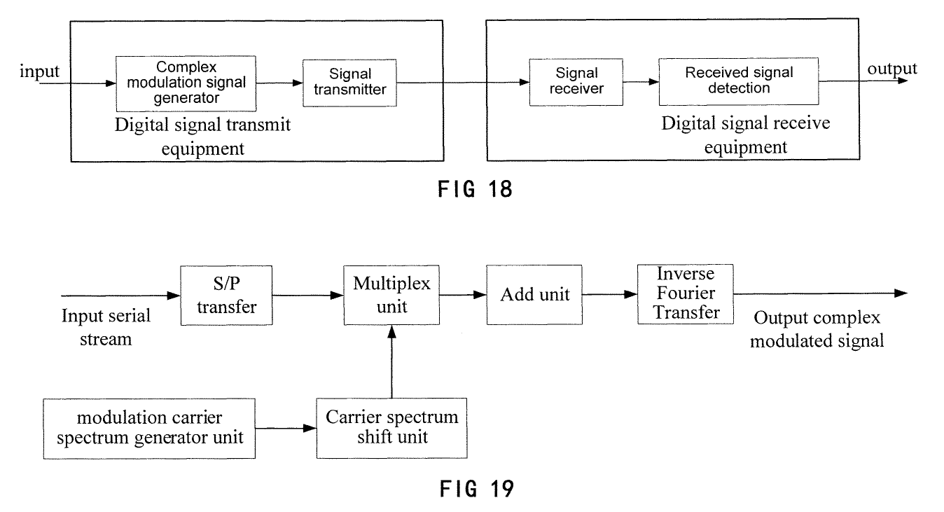

This implement provides a FDM system depicted in FIG. 18. It includes the digital signal transmitting and receiving equipments. The digital signal transmitting equipment includes complex modulation signal generator and signal transmitter; the receiving equipment includes the signal receiver and the received signal detector.

The complex modulation signal generator of the digital signal transmitting equipment is used to generate the complex modulation signal modulated by multiple overlapped sub-carriers; the signal transmitter is used to transmit the complex modulation signal.

The complex modulation signal generator depicted in FIG. 19 includes the S/P transformation unit, the modulation carriers' spectrum generation unit, the carriers' spectrum shift unit, the product unit, the add unit and the unit of inverse Fourier transform. The detailed description of these units is as follows.

The S/P transformation unit is used to transform serial bit stream into a number of parallel data symbol sequences.

The modulation carriers' spectrum generation unit is used to generate the filtering spectrum signal of the first or the last sub-carrier's In-phase component I and Quadrature component Q.

The carriers' spectrum shift unit is used to successively shift the filtering spectrum signal of the first or the last sub-carrier's In-phase component I and quadrature component Q ΔB as the next sub-carrier's In-phase component I and quadrature component Q′s filtering spectrum signal. ΔB is the spectrum interval between the sub-carriers. Then shift the next sub-carrier's In-phase component I and quadrature component Q's filtering spectrum signal ΔB. In this way, obtain all the sub-carriers' In-phase component I and quadrature component Q's filtering spectrum signals.

The product unit is used to make all the sub-carriers' In-phase component I and quadrature component Q's filtering spectrum signals that come from the carriers' spectrum shift unit multiplied by the multiple parallel data symbols' In-phase component I and quadrature component Q, Then obtain the multiple parallel symbols' modulated frequency symbols.

The add unit's function's to add all the multiple frequency symbols that come from the product unit.

The inverse Fourier transform unit is used to transform the frequency symbol that come from the add unit to time domain symbol.

The signal receiver of the receiving equipment is to receive the complex modulation signals modulated by multiple overlapped sub-carriers, which come from the digital signal transmitting equipment; the received signal detector is to detect the data symbol sequences according to the corresponding one-to-one mapping relationship between received symbols' frequency and transmitted data symbol sequences.

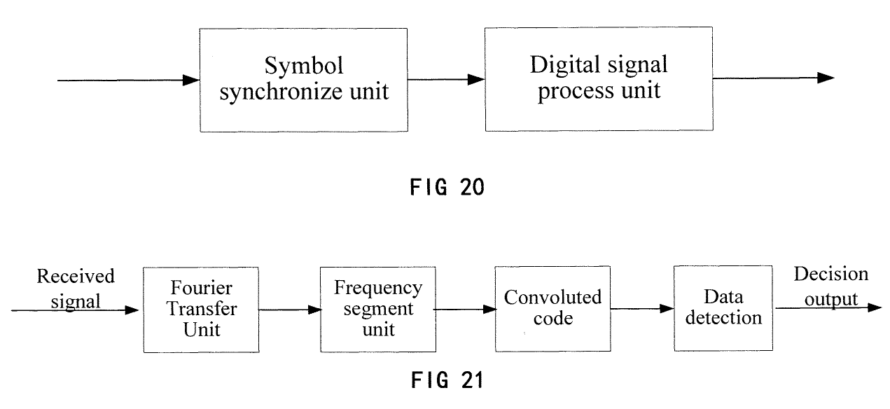

The signal receiver depicted in FIG. 20 includes the symbol synchronization unit that makes the received signals synchronous in time domain, the digital signal processing unit that samples and quantifies the received signals during every symbol time interval to make it to be digital signal sequences.

The received signal detector depicted in FIG. 21 include the Fourier transform unit that transforms the time domain signals received by the signal receiver described above to frequency domain signals, the frequency division unit that divides the frequency signals with the interval of ΔB to form the actual received signals' divided spectrum, the convolution code unit that forms the one to one mapping relationship between received signals' spectrum and transmitted data symbol sequences, the data detection unit that according to the one to one mapping relationship formed by the convolution code unit detects the data symbol sequences.

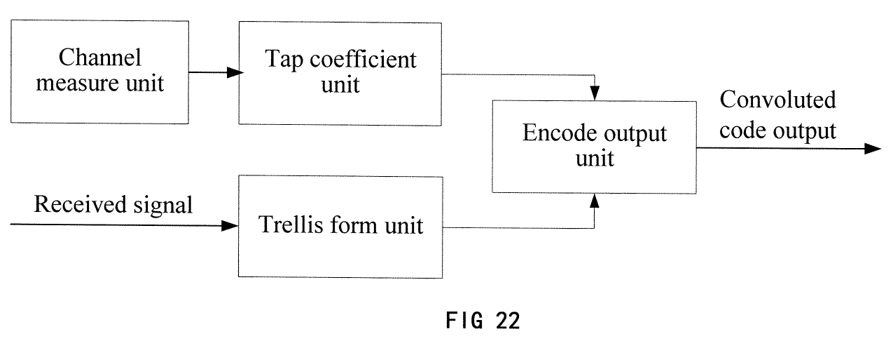

The convolution code unit depicted in FIG. 22, to go a step further, includes four parts: channel measuring unit, tap coefficient unit, trellis figure forming unit, code output unit. Among these, the channel measuring unit is used to measure the channel's linear transfer function \tilde{H}(t,f); the tap coefficient unit is used to form the coder's tap coefficients, that is, the overlapped sub-carriers' divided spectrum Ã_{l- k,k}(f), according to channel's linear transfer function \tilde{H}(t,f) and sub-carriers' spectrum; the trellis figure forming unit forms the trellis figure in frequency domain of the system described above; the code output unit works out every state transfer slip's code output that is the received signal's divided spectrum according to the tap coefficient and trellis figure in frequency domain.

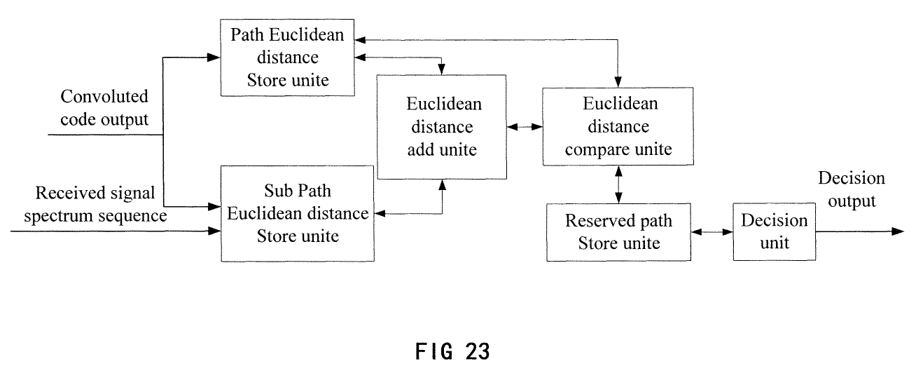

The data detection unit depicted in FIG. 23, to go a step further, includes the surviving path storage unit, the path Euclidean distance storage unit, the slip Euclidean distance storage unit, the Euclidean distance add unit, the Euclidean distance compare unit and the decision unit. The detail description of these units is as follows:

The surviving path storage unit stores the surviving path of all the states s when arrives at the lth node (l=1, . . . ,L−K+1).

The path Euclidean distance storage unit stores the Euclidean distance or weighted Euclidean distance in the frequency domain between the surviving path of all the states s when arrives at the lth node (l=1, . . . ,L−K+1) and the actual received signals' divided spectrum. There, the path Euclidean distance storage unit can only storages the relative distance, that is, let the maximum or the minimum path Euclidean distance or weighted Euclidean distance to be zero, the path Euclidean distance or weighted Euclidean distance storages of all other states only store the differential value compared with it, that is, the relative Euclidean distance.

The slip Euclidean distance storage unit is used to store the Euclidean distance or weighted Euclidean distance between the slip code output of all slips and the actual received signals' divided spectrum for all states s when arrived the lth node (l=1, . . . ,L−K+1).

The Euclidean distance add unit's function is that, when arrived at the lth node (l=1, . . . ,L−K+1), for any state s, make the values from the slip Euclidean distance storage unit added by the values of every starting state's path Euclidean distance storage unit of this state s, obtain the multiple added values.

The Euclidean distance compare unit's function is to compare all the values of the Euclidean distance add unit and chose the minimum value to update the surviving path storage unit's value of state s.

The decision unit is to check every state's surviving path storage unit, once find the same initial part in these surviving path, it will make the same initial part as the detection output and at the same time free the storage spaces.

The method and system of frequency division multiplexing of the present invention is not meant to be limited to the aforementioned prototype system, and the subsequent specific description utilization and explanation of certain characteristics previously recited as being characteristics of this prototype system are not intended to be limited to such technologies.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A frequency division multiplexing method, said method comprising:
a) Utilizing multi-spectral overlapping sub-carriers to modulate transmitted data symbol sequence,
b) Forming complex modulation signal,
c) Using this overlapping to form one to one relation between spectrum of received signals and transmitted data symbol sequence in receiver, and
d) Detecting the data symbol sequence.

2. A method as recited in claim 1 wherein said spectral spectral overlapping of multiple sub-carriers has the order of overlapped sub carrier greater than or equal to 3.

3. A method as recited in claim 2 wherein said one to one relation for said spectrum of received signals can be obtained from convolutional coding relation between transmitted data symbol sequence and overlapped sub carrier spectrum.

4. A method as recited in claim 3, wherein said method comprising:
a) Determining the design parameters according to channel parameters and system parameters,
b) Forming complex modulation signal and transmitting the signal according to channel parameters, system parameters and design parameters,
c) Receiving transmitted complex modulation signal,
d) Establishing relation between spectrum of received signal and transmitted data symbol sequence, and
e) Detecting the received signal according to said one to one relation.

5. A method as recited in claim 4 wherein said method further comprising:
a) Channel parameters including maximum time dispersion Δ or coherence bandwidth of channel
$${Ω}^{o} = \frac{1}{Δ} ,$$
maximum frequency spread of channel [symbol] or coherence time of channel
$${t}^{o} = \frac{1}{{F}^{o}} ,$$
b) System parameters described at least including system bandwidth B,
c) Design parameters including number of information bits loaded by each modulation symbol Q, number of modulation levels M=2^{Q}, length of basic symbol Tₛ, spectrum width of modulation signal B0, sub carrier frequency spacing ΔB or overlapped order of spectrum K and total number of sub carriers L, and
d) Length of basic symbol described Tₛ and maximum time dispersion Δ with Tₛ>>Δ∘

6. A method as recited in claim 4 wherein said complex modulation signal achieved in frequency domain, said method comprising:
a) Converting serial bit scream to multipath data symbol sequences which are transmitted in parallel,
b) Producing filtering frequency signal of in-phase I components and quadrature phase Q components of the first or the last sub carrier,
c) Filtering frequency signal of said in-phase I components and said quadrature phase Q components of the first or the last sub carrier shifted in frequency domain with spectrum spacing of sub carrier ΔB orderly obtaining filtering frequency signal of said in-phase I components and said quadrature phase Q components of the next sub carrier filtering frequency signal of said in-phase I components and said quadrature phase Q components of the next sub carrier shifted with spectrum spacing of sub carrier ΔB, and repeating the above operation filtering frequency signal of said in-phase I components and quadrature phase Q components of all sub carriers,
d) Multiplying said filtering frequency signal of said in-phase I components and said quadrature phase Q components of all sub carriers and complex of said in-phase components and quadrature components corresponding to data symbol sequence of various sub carrier, and obtaining spectrums of modulation symbols modulated by various sub carriers,
e) Summing spectrums of said modulation signals to form the complex modulation signals,
f) Performing Inverse Discrete Fourier Transform for spectrum of said complex modulation signals and forming complex modulation signals in time domain.

7. A method as recited in claim 4 wherein receiving transmitted complex modulation signals said method comprising:
a) Forming symbol synchronization for received signals in time domain, and
b) Sampling and quantizing said received signals in each time interval according to sampling theorem and converting the signals into received digital signal sequence.

8. A method as recited in claim 4 wherein establishing said one to one relation between spectrum of received signal and transmitted data symbol sequence, said method comprising:
a) Measuring linear transfer function of actual channel \tilde{H}(t,f),
b) Obtaining k sub spectrum of overlapped sub carrier Ã_{l-k,k}(f) according to \tilde{H}(t,f) and sub carrier spectrum Ã(f),
c) Obtaining sub spectrum of received signal according to transmitted data symbol sequence ũₙₗ₋ₖ and k sub spectrum of overlapped sub carrier Ã_{l-k,k}(f).

9. A method as recited in claim 4 wherein said method comprising detecting received signal according to said one to one relation by using maximum likelihood sequence detection method.

10. A method as recited in claim 9 wherein said steps of maximum likelihood sequence detection method further comprising:
a) Obtaining sub spectrum of actual received signal,
b) Using maximum likelihood sequence detection for sub spectrum of each said actual received signal.

11. A method as recited in claim 10 wherein obtaining said spectrum of said received signal, said method comprising:
a) A Fourier transform utilized to the receive digital signal sequence to obtain the spectrum of said actual received signal in each Interval of symbols, and
b) The spectrum of said actual received signal divided into sub-spectrum of received signal by the spectrum interval ΔB.

12. A method as recited in claim 10 wherein said maximum likelihood sequence detection applied to said sub-spectrum of said receive signal, said method comprising:
a) According to the modulation level M=2^{Q} and re-overlapping spectrum factor k, the initial state, the final state, the former state of transition, the latter state of transition and steady state, as well as the relations between the states,
b) The trellis graph arriving in the frequency domain according to the total number of subcarriers L and the relations between the states,
c) Reaching the Sub-spectrum of said receive signal by using the relations between the states in the transfer slip of all the states, according to the sub-carrier frequency spectrum and channel characteristics,
d) Obtaining the minimum Euclidean distance or minimum weighted Euclidean distance path by searching said sub-spectrum of receive signal arrived from said transfer slip of all the states and said actual sub-spectrum of received signal in said frequency domain trellis graph.

13. A method as recited in claim 12 wherein said method further comprising:
a) Said state corresponding to the data sequence of K−1 overlapped Q-dimensional binary symbols,
b) Said former state of transition meaning that there exit states in which Q-dimensional data less than or equal to K−2 overlapped is zero in the former of data sequence of K−1 overlapped Q-dimensional binary symbols,
c) Said latter state of transition meaning that there exit states in which Q-dimensional data less than or equal to K−2 overlapped is zero in the latter of data sequence of K−1 overlapped Q-dimensional binary symbols;
d) Said initial state meaning that all the data sequence of K−1 overlapped Q-dimensional binary symbols are zeros and it can only transfer to said former state of transition,
e) Said final state meaning that all the data sequence of K−1 overlapped Q-dimensional binary symbols are zeros and it can only transfer to said latter state of transition, and
f) Said steady state meaning that all the data sequence of K−1 overlapped Q-dimensional binary symbols are non-zero.

14. A method as recited in claim 12 wherein searching said minimum Euclidean distance or minimum weighted Euclidean distance path between said sub-spectrum of received signal arriving from the transfer branch of all the states and said actual sub-spectrum of received signal in the frequency domain trellis graph, said search method further comprising:
a) Letting the path Euclidean distance or weighted Euclidean distance of the initial node state is zero,
b) Computing the branch Euclidean distance or weighted branch Euclidean distance between sub-spectrum of said received signal transferred from said former state to current state and said sub-spectrum of said actual receive signal for all the states S of the lth node,
c) Forming a new or many path Euclidean distances or weighted Euclidean distances by adding all said branch Euclidean distance or weighted branch Euclidean distance transferring to said each state S to all said branch Euclidean distance or weighted branch Euclidean distance transferred from each state,
d) choosing the smallest path Euclidean distance from many path Euclidean distances considered as the path Euclidean distance or weighted Euclidean distance of the lth state S to update the path of the Euclidean distance or weighted Euclidean distance of said state,
e) For each state S of node 1, finding the surviving path corresponding to the path of the Euclidean distance or weighted Euclidean distance to update the surviving path of said state,
f) For the next node, repeating above said steps until the L+K−2th node,
g) Checking the storage unit of surviving path of various states, and considering the initial parts as the output if there is the same initial part of their surviving paths, and releasing said storage unit.

15. A method as recited in claim 14 wherein said storage of path Euclidean distance storing relative distance, said method comprising:
a) Setting the minimum or the maximum path Euclidean distance or weighted Euclidean distance to be zero, and
b) Said storage of path Euclidean distance or weighted Euclidean distance of all the other states only storing the relative distance of Euclidean distance.

16. A frequency division multiplexing system, utilizing digital signal devices to send and receive digital signal device, said system comprising:
a) The digital signal sending devices including complex modulation signal generator used to generate complex modulation signal modulated by multiple overlapping sub-carriers, and signal transmitter used to send the complex modulation signal, and
b) The digital signal receiving devices including signal receiver used to receive said complex modulation signal, and the receive signal detector used to detect the symbol sequence by one to one mapping relation between the spectrum of the received signal and the sent symbol sequence.

17. A system as recited in claim 16 wherein said overlapping has the overlapping factor greater than or equal to the number 3 for said overlapped sub-carriers.

18. A system as recited in claim 16 wherein said complex modulation signal generator comprising:
a) Serial to parallel transform units used to transform the serial bit stream to multiple parallel data transmission sequence of symbols,
b) Carrier spectrum generator used to produce filtering frequency signal of in-phase part I and orthogonal part Q for the first or the last sub-carrier,
c) Carrier spectrum transfer unit used to shift the filtering frequency signal of in-phase part I and orthogonal part Q for the first or the last sub-carrier to get the next filtering frequency signal of in-phase part I and orthogonal part Q for the next sub-carrier by frequency spectrum interval ΔB. and further shifting the filtering frequency signal of in-phase part I and orthogonal part Q for the next sub-carrier to get the filtering frequency signal of in-phase part I and orthogonal part Q for the next following sub-carrier, in turn, obtaining the filtering frequency signal of in-phase part I and orthogonal part Q for all the sub-carriers,
d) Multiplication unit used to multiply all the sub-carrier's same phase value I and orthogonal value Q′s filtering frequency spectrum signal obtained from the carriers frequency shift unit and the multi-parallel data transmission sequence of symbols' same phase value I and orthogonal value Q generated by said serial-to-parallel unit,
e) Sum unit used to sum every frequency spectrum generated by said multiplication unit,
f) Inverse-Fourier transform unit used to transform the spectrum signals generated by said sum unit into the time domain signal.

19. A system as recited in claim 16 wherein said signal receiver comprising:
a) Symbol synchronization unit used to make the receiving signals synchronous in the time-domain, and
b) Digital signal processing unit used to sample and quantify the received signal in the time domain of each symbol to make it a digital signal sequence.

20. A system as recited in claim 16 wherein said received signals detector comprising:
a) Fourier transform unit used to transfer the signal receiver's time-domain signal into a frequency domain signal,
b) Sub-frequency modules unit used to divide the signal spectrum by some interval in the frequency domain, and forming the actual sub-frequency spectrum of the received signal,
c) Convolution coding unit used to form the one-to-one mapping relationship between the spectrum of receive signals and the sending data,
d) Data detection unit used to detect the sequence data symbol by said one-to-one mapping relationship of said Convolution coding unit.

21. A system as recited in claim 29 wherein said convolution coding units further comprising:
a) Channel measurement unit used to measure the linear channel transfer function,
b) Tap coefficient unit used to compute the encoder tap factor which is the overlapping sub-carrier's sub-spectrum by the channel linear transfer function as well as the sub-carrier frequency spectrum,
c) Grid map generate unit used to form frequency domain grid map, and Coding output unit used to generate each state's branch coding output which is the sub-spectrum of the received signals by said tap coefficient system and frequency domain's grid map.

22. A system as recited in claim 20 wherein said data detecting units further comprising:
a) The path memory cell storing all the remained path of the state S reaching towards the 1th node,
b) The path Euclidean distance storage unit used to store the Euclidean distance or weighted Euclidean distance between all the reached state S of the lth node to the actual path of the received signals in the sub frequency spectrum region,
c) The branch Euclidean distance storage unit for all the state in the lth node used to store all the Euclidean distance or branch weighted Euclidean distance between all the coding output of the previous state to current state to the actual sub-spectrum signal branch,
d) Euclidean distance sum unit used to sum each state S′ branch Euclidean distance storage unit and the state S′ every starting path's Euclidean distance value,
e) Euclidean distance comparison unit used to compare the results of the Euclidean distance sum unit, find the minimum value, use it to update the storage unit to retain path and the corresponding value of state S,
f) Decision unit used to check the remained path of said storage unit's value of each state, and outputting it as decision result if they retain the same path in the initial part, and at the same time releasing the storage space.

23. A system as recited in claim 22 wherein said path memory cells retain only the relative distance by setting the largest or smallest of the path Euclidean distance or path-weighted Euclidean distance to be zero, and the memory of the other state's path Euclidean distance or path-weighted Euclidean distance only stores the difference called the relative Euclidean distance.
